(19) United States
(12) Patent Application Publication
(10) Pub. No.: US 2025/0296353 A1
(43) Pub. Date: Sep. 25, 2025

(54) PRINTING DEVICE, METHOD FOR PRODUCING PRINTED TEXTILE ITEM, AND PRINTING SYSTEM

(71) Applicant: RISO KAGAKU CORPORATION, Tokyo (JP)

(72) Inventors: Ryo SHINOTSUKA, Tokyo (JP); Yuki URANO, Tokyo (JP)

(21) Appl. No.: 19/059,005

(22) Filed: Feb. 20, 2025

(30) Foreign Application Priority Data
Mar. 19, 2024 (JP) 2024-043712
Mar. 21, 2024 (JP) 2024-045109

(51) Int. Cl. B41J 3/407; B41J 2/21; B41J 11/00; D06P 5/00; D06P 5/30

(52) U.S. Cl. CPC B41J 3/4078; B41J 2/2103; B41J 2/2117; B41J 11/002; D06P 5/002; D06P 5/30

(57) ABSTRACT

The disclosure relates to a printing device including a pretreatment liquid jetting section which jets a pretreatment liquid that causes ink coagulation, an ink jetting section which jets an ink, and a control section which performs control such that the pretreatment liquid jetting section jets the pretreatment liquid onto a fabric, and the ink jetting section jets the ink onto the fabric onto which the pretreatment liquid has been jetted, thereby printing a main image and an additional image.

### CROSS REFERENCE TO RELATED APPLICATIONS

This application is based upon and claims the benefit of priority from the Japanese Patent Application No. 2024-043712, filed on Mar. 19, 2024, and the benefit of priority from the prior Japanese Patent Application No. 2024-045109, filed on Mar. 21, 2024, the entire contents of which are incorporated by reference herein.

### BACKGROUND OF THE INVENTION

### Field of the Invention

The present disclosure relates to a printing device, a method for producing a printed textile item, and a printing system.

### Description of the Related Art

Technology for printing images such as text, pictures and patterns onto fabric such as clothing to produce printed textile items is already well known. For such items, there is a demand for being able to erase only a portion of an image on a printed textile item.

For example, in those cases where T-shirts or the like used as event goods are printed with an image that includes an advertising image that is only necessary for a comparatively short period from the day of the event, in some cases it may be desirable to erase the advertising image after the required period has passed but retain other portions of the image.

In this regard, JP 7130292 B discloses a technique in which at least two types of ink including an ink having high washing fastness and an ink having low washing fastness are printed to form colored portions, and the colored portion formed from the ink having low washing fastness discolors, fades, bleaches or disappears, leaving the colored portion formed from the ink having high washing fastness visible.

By using this technique, the image that is to be removed can be erased, leaving the image that is to be retained, by washing the fabric on which the image for removal and the image for retention have been printed.

### SUMMARY OF THE INVENTION

One aspect of the present disclosure provides a printing device including a pretreatment liquid jetting section which jets a pretreatment liquid that causes ink coagulation, an ink jetting section which jets an ink, and a control section which performs control such that the pretreatment liquid jetting section jets the pretreatment liquid onto a fabric, and the ink jetting section jets the ink onto the fabric onto which the pretreatment liquid has been jetted, thereby printing a main image and an additional image, wherein the control section controls the pretreatment liquid jetting section and the ink jetting section such that the main image is printed with the weight ratio of the pretreatment liquid relative to the ink adjusted so that the washing fastness of the region of the fabric on which the main image has been printed reaches at least a prescribed first level, and the additional image is printed with the weight ratio of the pretreatment liquid relative to the ink adjusted so that the washing fastness of the region of the fabric on which the additional image has been printed is no higher than a prescribed second level that is lower than the first level.

Another aspect of the present disclosure provides a method for producing a printed textile item, the method including a step of printing a main image by jetting a pretreatment liquid that causes ink coagulation onto a fabric, and then jetting an ink onto the fabric onto which the pretreatment liquid has been jetted, and a step of printing an additional image by jetting the pretreatment liquid onto the fabric, and then jetting an ink onto the fabric onto which the pretreatment liquid has been jetted, wherein in the step of printing the main image, the main image is printed with the weight ratio of the pretreatment liquid relative to the ink adjusted so that the washing fastness of the region of the fabric on which the main image has been printed reaches at least a prescribed first level, and in the step of printing the additional image, the additional image is printed with the weight ratio of the pretreatment liquid relative to the ink adjusted so that the washing fastness of the region of the fabric on which the additional image has been printed is no higher than a prescribed second level that is lower than the first level.

Yet another aspect of the present disclosure provides a printing system including a printing device which prints image information and post-treatment control information using a pretreatment liquid and an ink, a post-treatment device which reads the post-treatment control information with a reading section, and executes a post-treatment based on the read post-treatment control information, a first printing control section which conducts printing using a ratio between the weights of the pretreatment liquid and the ink that yields a high washing fastness, a second printing control section which conducts printing using a ratio between the weights the pretreatment liquid and the ink that yields a washing fastness lower than the washing fastness of the first printing control section, and a printing system control section which uses the first printing control section to cause the printing device to conduct printing based on the image information and uses the second printing control section to cause the printing device to print control information for the post-treatment device as the post-treatment control information, causes the reading section to read the printed post-treatment control information, and then controls the post-treatment device based on the read post-treatment control information.

### BRIEF DESCRIPTION OF THE DRAWINGS

FIG. 1 is a block diagram illustrating a schematic outline of a printing system of one example of a first embodiment.

FIG. 2 is a schematic illustration of the printing section of a printing device of the printing system illustrated in FIG. 1.

FIG. 3 is a flowchart describing the operation of the printing system illustrated in FIG. 1.

FIG. 4 is a diagram illustrating one example of an application screen.

FIG. 5 is a diagram illustrating one example of an unwashed fabric printed with a main image and an additional image.

FIG. 6 is a diagram illustrating a state in which the additional image on the fabric illustrated in FIG. 5 has been erased by washing.

FIG. 7 is an overall structural diagram of a printing system of one example of a second embodiment.

FIG. 8 is a schematic illustration of a printing device and drying devices of the printing system illustrated in FIG. 7.

FIG. 9 is a schematic illustration of a printing section of the printing device of the printing system illustrated in FIG. 7.

FIG. 10 is an explanatory diagram illustrating one example of the setting content of the post-treatment control information in the printing system illustrated in FIG. 7.

FIG. 11 is a diagram illustrating the evaluation results of evaluating washing fastness in the printing systems of Example 1 to Example 4 in Test Example 2.

FIG. 12 is a diagram illustrating the evaluation results of evaluating washing fastness in the printing systems of Example 5 and Example 6 in Test Example 2 and a comparative example.

FIG. 13 is a flowchart illustrating the processing content in the printing system illustrated in FIG. 7.

### DETAILED DESCRIPTION OF THE EMBODIMENTS

Embodiments of the present disclosure are described below with reference to the drawings. Regions and structural elements that are the same or similar across multiple drawings are labeled using the same or similar symbols.

The embodiments described below illustrate devices and the like that embody the technical concepts of this invention, but these technical concepts of the invention are not limited by the materials, shapes, structures or positions or the like of the various structural components. The technical concepts of this invention may be subjected to various modifications within the scope of the attached claims.

### First Embodiment

A first embodiment is described below.

One example of the first embodiment provides a printing device including a pretreatment liquid jetting section which jets a pretreatment liquid that causes ink coagulation, an ink jetting section which jets an ink, and a control section which performs control such that the pretreatment liquid jetting section jets the pretreatment liquid onto a fabric, and the ink jetting section jets the ink onto the fabric onto which the pretreatment liquid has been jetted, thereby printing a main image and an additional image, wherein the control section controls the pretreatment liquid jetting section and the ink jetting section such that the main image is printed with the weight ratio of the pretreatment liquid relative to the ink adjusted so that the washing fastness of the region of the fabric on which the main image has been printed reaches at least a prescribed first level, and the additional image is printed with the weight ratio of the pretreatment liquid relative to the ink adjusted so that the washing fastness of the region of the fabric on which the additional image has been printed is no higher than a prescribed second level that is lower than the first level.

Moreover, another example of the first embodiment provides a method for producing a printed textile item, the method including a step of printing a main image by jetting a pretreatment liquid that causes ink coagulation onto a fabric, and then jetting an ink onto the fabric onto which the pretreatment liquid has been jetted, and a step of printing an additional image by jetting the pretreatment liquid onto the fabric, and then jetting an ink onto the fabric onto which the pretreatment liquid has been jetted, wherein in the step of printing the main image, the main image is printed with the weight ratio of the pretreatment liquid relative to the ink adjusted so that the washing fastness of the region of the fabric on which the main image has been printed reaches at least a prescribed first level, and in the step of printing the additional image, the additional image is printed with the weight ratio of the pretreatment liquid relative to the ink adjusted so that the washing fastness of the region of the fabric on which the additional image has been printed is no higher than a prescribed second level that is lower than the first level.

The first embodiment relates to the technical field described below.

In the technique described in JP 7130292 B, a plurality of types of ink having different washing fastness levels are required. In other words, an additional ink must be used so that the image that is to be erased and the image that is to be retained are printed with different inks.

The first embodiment has been developed in light of these circumstances, and has an object of providing a printing device and a method for producing a printed textile item which, without using an additional ink, can produce a printed textile item for which it is possible to erase only a portion of the printed image.

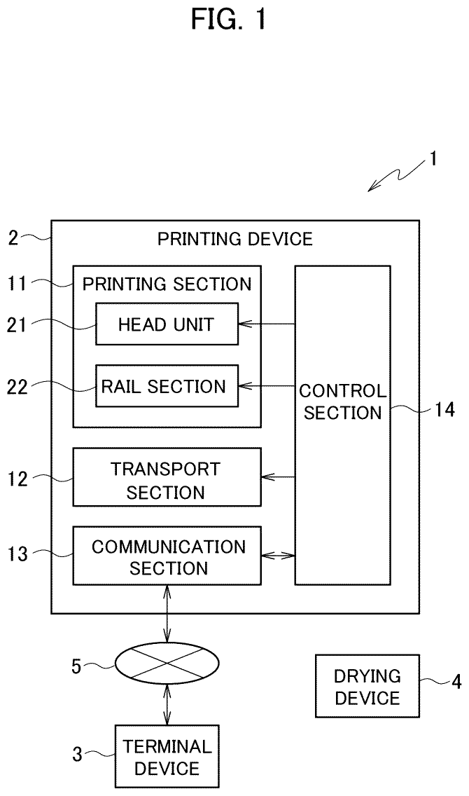

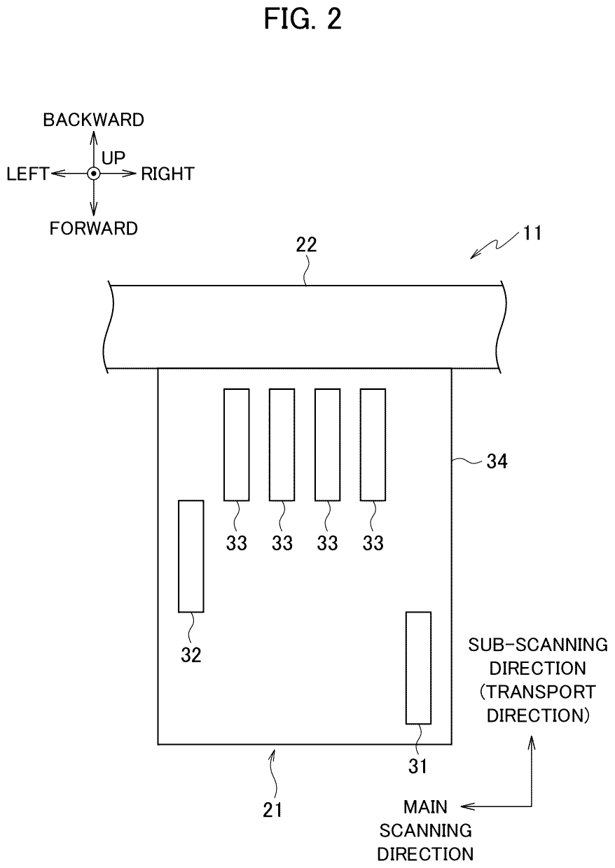

Specifics of the first embodiment are described below using the drawings. FIG. 1 is a block diagram illustrating a schematic outline of a printing system provided with a printing device that represents one example of the first embodiment. FIG. 2 is a schematic illustration of the printing section of the printing device of the printing system illustrated in FIG. 1. In FIG. 2, the direction orthogonal to the surface of the paper is deemed the vertical direction, with the direction extending from the upper surface of the paper indicating the upward direction. Further, the top, bottom, left and right of the paper surface indicate the forward, backward, left and right directions respectively.

As illustrated in FIG. 1, the printing system 1 includes a printing device 2, a terminal device 3, and a drying device 4. The printing device 2 and the terminal device 3 can communicate with each other via a network 5 formed from a LAN or the like.

The printing device 2 performs printing onto a fabric that represents the printing medium. The printing device 2 is, for example, a so-called garment printer used for printing to clothing such as T-shirts.

Examples of the fabric include natural fibers such as cotton, silk, wool and linen; chemical fibers such as polyester, acrylic, polyurethane, nylon, rayon, cupra and acetate; and mixed spun fibers of these fibers. Further, the fabric may be a woven fabric, a knitted fabric, or a nonwoven fabric or the like.

The printing device 2 includes a printing section 11, a transport section 12, a communication section 13, and a control section 14.

The printing section 11 performs printing onto the fabric using an inkjet method. The printing section 11 includes a head unit 21 and a rail section 22.

The head unit 21 conducts printing by jetting a pretreatment liquid and ink (white ink and color inks) onto the fabric. As illustrated in FIG. 2, the head unit 21 includes a pretreatment liquid jetting head 31, a white ink jetting head 32, a plurality of color ink jetting heads 33, and a head holder 34.

The pretreatment liquid jetting head 31, the white ink jetting head 32 and the color ink jetting heads 33 correspond with the ink jetting section. Further, the pretreatment liquid jetting head 31 corresponds with the pretreatment liquid jetting section, the white ink jetting head 32 corresponds with a white ink jetting section, and the color ink jetting heads 33 correspond with a color ink jetting section.

The pretreatment liquid jetting head 31 jets a pretreatment liquid. The pretreatment liquid jetting head 31 opens at the lower surface (the jetting surface), and has a plurality of nozzles (not shown in the drawing) aligned along the forward-backward direction (the sub-scanning direction), with the pretreatment liquid being jetted from these nozzles. Details of the pretreatment liquid are described below.

The white ink jetting head 32 jets a white ink. The white ink jetting head 32 has a similar structure to the pretreatment liquid jetting head 31, with the exception that the jetted liquid is different. The white ink jetting head 32 is disposed backward of the pretreatment liquid jetting head 31 in the forward-backward direction (the sub-scanning direction). Details of the white ink are described below.

The color ink jetting heads 33 jet color inks. In the case of the printing device 2, four color ink jetting heads 33 are provided which jet black, cyan, magenta and yellow inks respectively. The color ink jetting heads 33 have a similar structure to the pretreatment liquid jetting head 31, with the exception that the jetted liquid is different. The four color ink jetting heads 33 are disposed backward of the white ink jetting head 32 in the forward-backward direction (the sub-scanning direction). The four color ink jetting heads 33 are aligned across the left-right direction (the main scanning direction). Details of the color inks are described below.

The head holder 34 holds the pretreatment liquid jetting head 31, the white ink jetting head 32, and the four color ink jetting heads 33.

The rail section 22 moves the head unit 21 back and forth across the left-right direction (the main scanning direction).

The transport section 12 has a holding section (not shown in the drawing) that holds the fabric, and transports the fabric held by the holding section in a transport direction (the sub-scanning direction) from the forward side toward the backward side beneath the head unit 21.

The communication section 13 conducts communication processing with the terminal device 3 via the network 5.

The control section 14 controls the overall operation of the printing device 2. The control section 14 is constructed from a CPU, RAM, ROM, and a hard disk and the like.

Specifically, the control section 14 performs control so that the pretreatment liquid jetting head 31 jets the pretreatment liquid onto the fabric, the white ink jetting head 32 jets the white ink onto the fabric to which the pretreatment liquid has been jetted, and the color ink jetting heads 33 jet the color inks onto the fabric to which the pretreatment liquid and the white ink has been jetted, thereby printing an image onto the fabric.

In some cases, an image including a main image which is an image composed of the main pattern or the like formed on the fabric, and an additional image which is an image that is only required for a short period of time are printed onto a single fabric item. The main image is printed as an image that does not disappear even with washing, whereas the additional image is printed as an image that disappears with washing. The additional image is, for example, an advertising image or the like which, when printing clothing such as T-shirts or the like, is to be displayed on the clothing for a short period of time.

In those cases where an image containing a main image and an additional image is to be printed, the control section 14 controls the pretreatment liquid jetting head 31, the white ink jetting head 32 and the color ink jetting heads 33 so that the main image is printed with the weight ratio of the pretreatment liquid relative to the ink (the white ink and the color inks) adjusted so that the washing fastness of the region of the fabric on which the main image has been printed reaches at least a prescribed first level, whereas the additional image is printed with the weight ratio of the pretreatment liquid relative to the ink adjusted so that the washing fastness of the region of the fabric on which the additional image has been printed is no higher than a prescribed second level that is lower than the first level.

The first level mentioned above indicates the lower limit for washing fastness that ensures the image is not erased by washing of the fabric. The first level may be set, for example, so that the change in color in washing fastness as prescribed in JIS L 0844 A-2 is grade 3 or higher.

Further, the second level mentioned above indicates the upper limit for washing fastness that ensures that the image disappears upon washing of the fabric. The second level may be set, for example, so that the change in color in washing fastness as prescribed in JIS L 0844 A-2 is grade 1.

The washing fastness of a fabric having a printed image is dependent mainly on the weight ratio of the pretreatment liquid relative to the ink. Specifically, the larger the weight ratio of the pretreatment liquid relative to the ink, the lower the washing fastness becomes.

The larger the weight ratio of the pretreatment liquid relative to the ink, the more the coating film of the ink is formed on the outer surface of the fabric. As a result, the ink coating film is more prone to damage caused by washing. Further, because the amount of the ink coating film intertwined with the fibers of the fabric is comparatively small, the ink coating film is more likely to detach from the fabric. Accordingly, the larger the weight ratio of the pretreatment liquid relative to the ink, the lower the washing fastness becomes.

Furthermore, in those cases where a liquid containing a metal salt is used as the pretreatment liquid, when a comparatively large amount of the metal salt of the pretreatment liquid exists within the ink coating film, washing causes the metal salt to dissolve, forming voids within the ink coating film. Washing causes cracks to develop in the ink coating film from these voids, making the ink coating film more likely to detach from the fabric. Accordingly, the larger the weight ratio of the pretreatment liquid relative to the ink, the lower the washing fastness becomes.

In order to achieve washing fastness that ensures the main image does not disappear even upon washing, the weight ratio of the pretreatment liquid relative to the ink when printing the main image is preferably 0.4 or lower. Further, in order to achieve washing fastness that ensures the additional image is erased upon washing, the weight ratio of the pretreatment liquid relative to the ink when printing the additional image is preferably 0.55 or higher.

The terminal device 3 transmits printing data to the printing device 2. The terminal device 3 is formed from a computer having a CPU, ROM, RAM, hard disk, a display section formed from a liquid crystal display panel or the like, and an input section having a keyboard and mouse or the like (although none of these components are shown in the drawings).

The drying device 4 dries the fabric that has been printed with the printing device 2. A heat press, roll heater, hot air device, or infrared lamp heater or the like can be used as the drying device 4.

Next is a description of the abovementioned pretreatment liquid.

The pretreatment liquid is a liquid that causes coagulation of the inks. A pretreatment liquid containing a coagulant and water can be used favorably as the pretreatment liquid. For the coagulant, a component having an action that causes coagulation of the coloring material in the ink on the fabric that represents the printing medium may be used. As a result, when an ink is applied to the fabric to which the pretreatment liquid has already been applied, the coloring material in the ink coagulates on the fabric, enabling the image density to be enhanced, and preventing bleeding of the image. Specific examples of coagulants that may be used include metal salts, cationic polymers and organic acids, as well as combinations of these materials.

The amount of the ink coagulant in the pretreatment liquid may be adjusted appropriately in accordance with factors such as the type of ink coagulant, and the composition of the ink applied to the fabric after the pretreatment liquid, but for example, may be at least 5% by mass, at least 10% by mass, or 15% by mass or greater. Further, the amount of the ink coagulant may be not more than 50% by mass, not more than 45% by mass, or 40% by mass or less. The amount of the ink coagulant in the pretreatment liquid may be, for example, within a range from 5 to 50% by mass.

Polyvalent metal salts can be used favorably as the metal salt. By using a polyvalent metal salt, the washing fastness can be more easily adjusted by altering the jetting amount of the pretreatment liquid, and printing can be more easily conducted in a manner that produces a main image that is not erased by washing of the fabric, and an additional image that is erased upon washing of the fabric.

Polyvalent metal salts are composed of a polyvalent metal ion having a valency of 2 or higher and an anion. Examples of the polyvalent metal ion having a valency of 2 or higher include Ca²⁺, Mg²⁺, Cu²⁺, Ni²⁺, Zn²⁺, and Ba²⁺. Examples of the anion include Cl⁻, NO₃⁻, CH₃COO⁻, I⁻, Br⁻, and ClO₃⁻. Specific examples of the polyvalent metal salt include calcium chloride, calcium nitrate, magnesium nitrate, copper nitrate, calcium acetate, and magnesium acetate.

Cationic water-soluble resins can be used favorably as the cationic polymer. Examples of cationic water-soluble resins include polyethyleneimine (PEI), polyvinylamine, polyallylamine and salts thereof, polyvinylpyridine, and cationic acrylamide copolymers. More specifically, polydiallyldimethylammonium chloride and the like may be used.

Examples of the organic acids include formic acid, acetic acid, oxalic acid, malic acid, citric acid, and ascorbic acid.

The pretreatment liquid preferably contains water. The pretreatment liquid may also contain a water-soluble organic solvent, either in addition to the water or instead of the water.

There are no particular limitations on the water, and examples of waters that may be used include ion-exchanged water, distilled water, and ultrapure water.

The amount of the water, relative to the total mass of the pretreatment liquid, is preferably within a range from 30 to 90% by mass, more preferably from 40 to 85% by mass, and even more preferably from 50 to 80% by mass.

For the water-soluble organic solvent, organic compounds that are liquid at room temperature (25° C.) and able to be dissolved in water may be used, and the use of a water-soluble organic solvent that mixes uniformly with an equal volume of water at one atmosphere and 20° C. is preferred. Examples of water-soluble organic solvents that can be used include:
lower alcohols such as methanol, ethanol, 1-propanol, isopropanol, 1-butanol, 2-butanol, isobutanol, 1,3-propanediol, 1,3-butanediol, 1,2-butanediol, 1,2-pentanediol, 1,2-hexanediol, and 2-methyl-2-propanol;
glycols such as ethylene glycol, diethylene glycol, triethylene glycol, tetraethylene glycol, polyethylene glycol, propylene glycol, dipropylene glycol, tripropylene glycol and polypropylene glycol;
glycerols such as glycerol, diglycerol, triglycerol and polyglycerol;
acetins such as monoacetin and diacetin;
glycol ethers such as ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether and tetraethylene glycol diethyl ether; and
β-thiodiglycol and sulfolane. The boiling point of the water-soluble organic solvent is preferably at least 100° C., and more preferably 150° C. or higher.

One of these water-soluble organic solvents may be used alone, or a combination of two or more types of organic solvent may be used. The amount of the water-soluble solvent, or the combined amount of all the water-soluble organic solvents in those cases where two or more organic solvents are used, relative to the total mass of the pretreatment liquid, is preferably within a range from 10 to 50% by mass, more preferably from 15 to 40% by mass, and even more preferably from 15 to 30% by mass.

The pretreatment liquid may also contain a surfactant. Examples of surfactants that may be used include anionic surfactants, cationic surfactants, amphoteric surfactants and nonionic surfactants, but nonionic surfactants are particularly preferred. Further, both low-molecular weight surfactants and polymer-based surfactants may be used.

The HLB value of the surfactant is preferably within a range from 5 to 20, and more preferably from 10 to 18.

Examples of the nonionic surfactants include ester-based surfactants such as glycerol fatty acid esters and fatty acid sorbitan esters; ether-based surfactants such as polyoxyethylene alkyl ethers, polyoxyethylene alkylphenyl ethers and polyoxypropylene alkyl ethers; ether ester-based surfactants such as polyoxyethylene sorbitan fatty acid esters; acetylene-based surfactants; silicone-based surfactants; and fluorine-based surfactants. Among these, acetylene-based surfactants such as acetylene glycol-based surfactants can be used particularly favorably.

Examples of the acetylene-based surfactants include acetylene glycol-based surfactants, acetylene alcohol-based surfactants, and surfactants having an acetylene group.

Acetylene glycol-based surfactants are glycols having an acetylene group, are preferably glycols having a left-right symmetrical structure with an acetylene group located in the center, and may include a structure in which ethylene oxide has been added to the acetylene glycol.

Examples of commercially available products of acetylene-based surfactants include the SURFYNOL series of products such as SURFYNOL 104E, SURFYNOL 104H, SURFYNOL 420, SURFYNOL 440, SURFYNOL 465 and SURFYNOL 485 manufactured by Evonik Industries AG, and the OLFINE series of products such as OLFINE E1004, OLFINE E1010 and OLFINE E1020 manufactured by Nissin Chemical Industry Co., Ltd. (wherein all of the above are brand names).

Examples of the silicone-based surfactants include polyether-modified silicone-based surfactants, alkyl-aralkyl-comodified silicone-based surfactants, and acrylic silicone-based surfactants.

Examples of commercially available products of silicone-based surfactants include SILFACE SAG002 and SILFACE 503A (both brand names) manufactured by Nissin Chemical Industry Co., Ltd.

Further examples of other nonionic surfactants include polyoxyethylene alkyl ether-based surfactants such as the EMULGEN series of products including EMULGEN 102 KG, EMULGEN 103, EMULGEN 104P, EMULGEN 105, EMULGEN 106, EMULGEN 108, EMULGEN 120, EMULGEN 147, EMULGEN 150, EMULGEN 220, EMULGEN 350, EMULGEN 404, EMULGEN 420, EMULGEN 705, EMULGEN 707, EMULGEN 709, EMULGEN 1108, EMULGEN 4085 and EMULGEN 2025G (all brand names) manufactured by Kao Corporation.

Examples of the anionic surfactants include the EMAL series of products such as EMAL 0, EMAL 10, EMAL 2F, EMAL 40 and EMAL 20C, the NEOPELEX series of products such as NEOPELEX GS, NEOPELEX G-15, NEOPELEX G-25 and NEOPELEX G-65, the PELEX series of products such as PELEX OT-P, PELEX TR, PELEX CS, PELEX TA, PELEX SS-L and PELEX SS-H, and the DEMOL series of products such as DEMOL N, DEMOL NL, DEMOL RN and DEMOL MS (all brand names) manufactured by Kao Corporation.

Examples of the cationic surfactants include the ACETAMIN series of products such as ACETAMIN 24 and ACETAMIN 86, the QUARTAMIN series of products such as QUARTAMIN 24P, QUARTAMIN 86P, QUARTAMIN 60W and QUARTAMIN 86W, and the SANISOL series of products such as SANISOL C and SANISOL B-50 (all brand names) manufactured by Kao Corporation.

Examples of the amphoteric surfactants include the AMPHITOL series of products such as AMPHITOL 20BS, AMPHITOL 24B, AMPHITOL 86B, AMPHITOL 20YB and AMPHITOL 20N (all brand names) manufactured by Kao Corporation.

A single type of surfactant may be used, or a combination of two or more types may be used.

The amount of the surfactant, expressed as the amount of the active ingredient relative to the total mass of the pretreatment liquid, is preferably within a range from 0.1 to 10% by mass, and more preferably from 0.2 to 5% by mass. In those cases where two or more types of surfactant are used, the above amount of the surfactant refers to the total amount of all the surfactants.

The pretreatment liquid may also contain other components. Examples of these other components include such as pH adjusters, preservatives, corrosion inhibitors, and antifoaming agents and the like.

There are no particular limitations on the method used for producing the pretreatment liquid, and production may be performed using appropriate conventional methods. For example, the pretreatment liquid may be obtained by using a stirring device such as a three-one motor to disperse all of the components, either in a single batch or in a number of separate batches, and then passing the resulting dispersion through a filtration device such as a membrane filter if desired.

Next is a description of the white ink mentioned above.

The white ink may be used in those cases where the fabric of the printing medium is a dark color such as black, and may be jetted onto the fabric to conceal the color of the fabric and make the printed image more visible.

The white ink may contain a white pigment as a coloring material. By incorporating a white pigment, the white ink can be used for forming an image that includes a white color. Examples of white pigments that may be used include inorganic pigments, organic pigments, and combinations thereof.

Examples of the white pigment include white inorganic pigments such as titanium oxide, zinc oxide, zinc sulfide, antimony oxide and zirconium oxide. Moreover, white organic pigments such as hollow resin microparticles and solid resin microparticles may also be used. Among the various possibilities, from the viewpoint of the concealment properties, the use of a titanium oxide pigment is preferred. The average particle size of the white pigment is preferably at least 50 nm, at least 100 nm, or 200 nm or larger from the viewpoint of the concealment properties, and is preferably not more than 500 nm, not more than 400 nm, or 300 nm or smaller from the viewpoint of the jetting stability. From the viewpoints of the concealment properties and the jetting stability, the average particle size of the titanium oxide pigment is more preferably within a range from 200 to 300 nm. In those cases where a titanium oxide pigment is used, in order to suppress any photocatalytic action, the use of titanium oxide that has been surface treated with alumina or silica is preferred. The amount of surface treatment preferably represents 5 to 20% by mass of the pigment.

A self-dispersing pigment may also be used as the white pigment. A self-dispersing pigment is a pigment in which a hydrophilic functional group has been introduced at the pigment surface by a chemical treatment or a physical treatment. The hydrophilic functional group introduced into the self-dispersing pigment is preferably a group having ionicity, and by imparting the pigment surface with either an anionic or cationic charge, the pigment particles can be stably dispersed in water by electrostatic repulsion. Preferred anionic functional groups include a carboxyl group, sulfonate group and phosphate group. Preferred cationic functional groups include quaternary ammonium groups and quaternary phosphonium groups and the like.

These hydrophilic functional groups may be bonded directly to the pigment surface, or may be bonded via another atom grouping. Examples of this other atom grouping include, but are not limited to, alkylene groups, phenylene groups and naphthylene groups. Examples of methods for treating the pigment surface include diazotization treatments, sulfonation treatments, hypochlorous acid treatments, humic acid treatments, and vacuum plasma treatments.

Pigment dispersions containing a pigment that has already been dispersed using a pigment dispersant may also be used as the white pigment. Further, microencapsulated pigments in which the pigment has been coated with a resin may also be used as the white pigment.

A single type of white pigment may be used, or a combination of two or more types may be used.

From the viewpoint of the concealing properties, the amount of the white pigment relative to the total mass of the white ink is preferably within a range from 5 to 30% by mass, more preferably from 8 to 20% by mass, and even more preferably from 10 to 12% by mass.

A pigment dispersant typified by polymer dispersants and surfactant-type dispersants and the like may be used to ensure stable dispersion of the white pigment in the white ink.

Examples of commercially available products of the polymer dispersants include the TEGO Dispers series of products such as TEGO Dispers 740W, TEGO Dispers 750W, TEGO Dispers 755W, TEGO Dispers 757W and TEGO Dispers 760W manufactured by Evonik Industries AG, the Solsperse series of products such as Solsperse 20000, Solsperse 27000, Solsperse 41000, Solsperse 41090, Solsperse 43000, Solsperse 44000 and Solsperse 46000 manufactured by The Lubrizol Corporation, the Joncryl series of products such as Joncryl 57, Joncryl 60, Joncryl 62, Joncryl 63, Joncryl 71 and Joncryl 501 manufactured by BASF Japan Ltd., as well as DISPERBYK-102, DISPERBYK-185, DISPERBYK-190, DISPERBYK-193 and DISPERBYK-199 manufactured by BYK-Chemie Japan K.K., and Polyvinylpyrrolidone K-30 and Polyvinylpyrrolidone K-90 manufactured by DKS Co. Ltd. (wherein all of the above are brand names).

Examples of the surfactant-type dispersants include anionic surfactants including the DEMOL series of products such as DEMOL P, DEMOL EP, DEMOL N, DEMOL RN, DEMOL NL, DEMOL RNL and DEMOL T-45 manufactured by Kao Corporation, and nonionic surfactants including the EMULGEN series of products such as EMULGEN A-60, EMULGEN A-90, EMULGEN A-500, EMULGEN B-40, EMULGEN L-40 and EMULGEN 420 manufactured by Kao Corporation (wherein all of the above are brand names).

A single type of the above pigment dispersants may be used, or a combination of two or more types may be used.

When used, there are no particular limitations on the amount of the pigment dispersant within the ink, which varies depending on the type of pigment dispersant used, but generally, the amount of the pigment dispersant, expressed as a mass ratio of the active ingredient relative to a value of 1 for the pigment, is preferably within a range from 0.005 to 0.5.

The white ink preferably contains water as an aqueous solvent, and the main solvent may be water. There are no particular limitations on the water, but water containing as few ionic components as possible is preferred. In particular, from the viewpoint of the ink storage stability, the amount of polyvalent metal ions such as calcium ions is preferably kept low. For example, the use of ion-exchanged water, distilled water or ultrapure water as the water is ideal.

From the viewpoint of adjustment of the ink viscosity, the amount of water relative to the total mass of the white ink is preferably within a range from 30 to 90% by mass, more preferably from 40 to 85% by mass, and even more preferably from 50 to 80% by mass.

The white ink may also contain a water-soluble organic solvent.

Examples of water-soluble organic solvents that may be used include solvents selected from among those described above in relation to the pretreatment liquid.

Among these organic solvents, from the viewpoints of adjustment of the ink viscosity and moisture retention, glycols, glycerols, and combinations thereof are preferred. Preferred glycols include ethylene glycol, diethylene glycol, triethylene glycol, tetraethylene glycol, propylene glycol, dipropylene glycol and tripropylene glycol. Glycerol is preferred as the glycerol.

One of these water-soluble organic solvents may be used alone, or a combination of two or more types of organic solvent may be used. The amount of the water-soluble organic solvent, or the total amount of all the water-soluble organic solvents in those cases where two or more organic solvents are used, relative to the total mass of the white ink, is preferably within a range from 10 to 50% by mass, more preferably from 15 to 40% by mass, and even more preferably from 15 to 30% by mass.

The white ink may also contain a surfactant. Examples of surfactants that may be used include surfactants selected from among those described above for the pretreatment liquid. Anionic surfactants, cationic surfactants, amphoteric surfactants and nonionic surfactants may all be used, but nonionic surfactants are particularly preferred. Further, both low-molecular weight surfactants and polymer-based surfactants may be used.

The amount of the surfactant, relative to the total mass of the white ink, is preferably within a range from 0.1 to 5% by mass, and more preferably from 0.2 to 2% by mass.

The white ink may also contain a water-dispersible resin, a water-soluble resin, or a combination thereof. From the viewpoint of fixing the pigment satisfactorily to the fabric, thereby achieving superior coloration with a small amount of pigment, the white ink preferably contains at least one of a water-dispersible resin and a water-soluble resin.

Examples of the water-soluble resin include polyvinyl alcohol, polyacrylic acid, neutralized products of polyacrylic acid, acrylic acid/maleic acid copolymers, acrylic acid/sulfonic acid copolymers, and styrene/maleic acid copolymers. One of these water-soluble resins may be used alone, or a combination of two or more such resins may be used.

The water-dispersible resin is preferably composed of resin particles that can be dispersed in an aqueous solvent. The water-dispersible resin may, for example, be able to be blended into the ink in the form of an oil-in-water resin emulsion.

The water-dispersible resin may be a self-emulsifying resin having an introduced hydrophilic component that enables stable dispersion in water, or may be converted to a water-dispersible form through use of an external emulsifier.

From the viewpoint of the inkjet jetting characteristics, the average particle size of the water-dispersible resin is preferably not more than 300 nm, more preferably not more than 200 nm, and even more preferably 150 nm or less. For example, the average particle size of the water-dispersible resin may be within a range from 10 nm to 300 nm.

Here, the average particle size of the water-dispersible resin refers to the volume-based average particle size, and is a numerical value that can be measured by a light scattering method.

The water-dispersible resin may be anionic, cationic, nonionic, or amphoteric. From the viewpoint of achieving more stable dispersion of the water-dispersible resin in the aqueous ink, the water-dispersible resin is preferably anionic or nonionic.

The water-dispersible resin is preferably an anionic water-dispersible resin having an anionic functional group such as a carboxyl group, sulfo group, or hydroxyl group.

In terms of the type of water-dispersible resin used, the use of a resin that forms a transparent coating film is preferred. Further, the water-dispersible resin may be blended in the form of a resin emulsion during production of the ink.

Representative examples of the water-dispersible resin include urethane resins, (meth)acrylic resins, styrene/(meth)acrylic resins, polyester resins, olefin resins, vinyl chloride resins, vinyl acetate resins, melamine resins, amide resins, ethylene-vinyl chloride copolymer resins, styrene-(meth)acrylic resins, styrene-maleic anhydride copolymer resins, vinyl acetate-(meth)acrylic copolymer resins, vinyl acetate-ethylene copolymer resins, silicone reins, and composite resins of the above resins.

The water-dispersible resin is preferably a water-dispersible urethane resin, a water-dispersible polyester resin, or a combination thereof.

Examples of commercially available products of water-dispersible resins include SUPERFLEX 470 manufactured by DKS Co., Ltd. (a water-dispersible urethane resin) and ELITEL KT9204 manufactured by Unitika Ltd. (a water-dispersible polyester resin) (wherein both of the above are brand names).

One of the above water-dispersible resins may be used alone, or a combination of two or more types of such resins may be used.

The amount of the water-dispersible resin, expressed as the amount of the non-volatile component relative to the total mass of the white ink, is preferably at least 1% by mass, more preferably at least 5% by mass, and even more preferably 10% by mass or greater. Further, the amount of the water-dispersible resin, expressed as the amount of the non-volatile component relative to the total mass of the white ink, is preferably not more than 40% by mass, more preferably not more than 30% by mass, and more preferably 20% by mass or less. For example, the amount of the water-dispersible resin, expressed as the amount of the non-volatile component relative to the total mass of the white ink, is preferably within a range from 1 to 40% by mass, more preferably from 5 to 30% by mass, and even more preferably from 10 to 20% by mass.

The amount of the water-dispersible resin, expressed as a mass ratio of the non-volatile component relative to a value of 1 for the amount of the pigment, is preferably within a range from 0.1 to 10, and more preferably from 1 to 3.

The total amount of the water-dispersible resin and the water-soluble resin, expressed as the total amount of the non-volatile components relative to the total mass of the white ink, is preferably at least 1% by mass, more preferably at least 5% by mass, and even more preferably 10% by mass or greater. Further, the total amount of the water-dispersible resin and the water-soluble resin, expressed as the total amount of the non-volatile components relative to the total mass of the white ink, is preferably not more than 40% by mass, more preferably not more than 30% by mass, and more preferably 20% by mass or less. For example, the total amount of the water-dispersible resin and the water-soluble resin, expressed as the total amount of the non-volatile components relative to the total mass of the white ink, is preferably within a range from 1 to 40% by mass, more preferably from 5 to 30% by mass, and even more preferably from 10 to 20% by mass.

The total amount of the water-dispersible resin and the water-soluble resin, expressed as a mass ratio of the total amount of the non-volatile components relative to a value of 1 for the amount of the pigment, is preferably within a range from 0.1 to 10, and more preferably from 1 to 3.

The white ink may also contain other components. Examples of these other components include pH adjusters, preservatives, corrosion inhibitors, antifoaming agents, and amine compounds.

There are no particular limitations on the method used for producing the white ink, and production may be performed using appropriate conventional methods. For example, the ink may be obtained by using a stirring device such as a three-one motor to disperse all of the components, either in a single batch or in a number of separate batches, and then passing the resulting dispersion through a filtration device such as a membrane filter if desired.

From the viewpoint of the ink storage stability, the pH of the white ink is preferably within a range from 7.0 to 10.0, and more preferably from 7.5 to 9.0.

The viscosity of the white ink may be adjusted as appropriate, and for example, from the viewpoint of the jetting characteristics, the viscosity at 23° C. is preferably within a range from 1 to 30 mPa·s.

Next is a description of the color inks mentioned above.

A black ink, a cyan ink, a magenta ink and a yellow ink are used as the color inks.

Each color ink may contain a pigment, a dye, or a combination thereof as the coloring material, but preferably contains a pigment.

A non-white pigment is preferably included as the pigment.

Organic pigments such as azo pigments, phthalocyanine pigments, polycyclic pigments and dye lake pigments, and inorganic pigments such as carbon blacks and metal oxides may be used as the non-white pigment. Examples of the azo pigments include soluble azo lake pigments, insoluble azo pigments and condensed azo pigments. Examples of the phthalocyanine pigments include metal phthalocyanine pigments and metal-free phthalocyanine pigments. Examples of the polycyclic pigments include quinacridone-based pigments, perylene-based pigments, perinone-based pigments, isoindoline-based pigments, isoindolinone-based pigments, dioxazine-based pigments, thioindigo-based pigments, anthraquinone-based pigments, quinophthalone-based pigments, metal complex pigments and diketopyrrolopyrrole (DPP). Examples of the carbon blacks include furnace carbon black, lamp black, acetylene black and channel black. Any one of these pigments may be used alone, or a combination of two or more types of pigment may be used.

From the viewpoints of the jetting stability and the storage stability, the average particle size of the pigment particles in the ink, expressed as the volume-based average value in a particle size distribution measured by a dynamic light scattering method, is preferably not more than 300 nm, more preferably not more than 150 nm, and even more preferably 100 nm or less.

A self-dispersing pigment may be used as the non-white pigment. Details regarding self-dispersing pigments are as described above in relation to the white pigment.

Examples of products that can be used favorably as self-dispersing pigments include the CAB-O-JET series of products such as CAB-O-JET 200, CAB-O-JET 300, CAB-O-JET 250C, CAB-O-JET 260M, CAB-O-JET 270 and CAB-O-JET 450C manufactured by Cabot Corporation, and BONJET BLACK CW-1, BONJET BLACK CW-2, BONJET BLACK CW-3 and BONJET BLACK CW-4 manufactured by Orient Chemical Industries, Ltd. (wherein all of the above are brand names).

Microencapsulated pigments in which the pigment has been coated with a resin may also be used as the pigment.

Pigment dispersions containing a pigment that has already been dispersed using a pigment dispersant may also be used. Examples of commercially available products of pigment dispersions that have been dispersed using a pigment dispersant include the HOSTAJET series of products manufactured by Clariant AG, and the FUJI SP series of products manufactured by Fuji Pigment Co., Ltd.

Examples of dyes that can be used favorably include water-soluble dyes and dyes that have been made water-soluble by reduction or the like, selected from among basic dyes, acid dyes, direct dyes, soluble vat dyes, acid mordant dyes, mordant dyes, reactive dyes, vat dyes and sulfide dyes. Further, dispersible dyes such as azo-based dyes, anthraquinone-based dyes, azomethine-based dyes and nitro-based dyes can also be used favorably. One of these dyes may be used alone, or a combination of a plurality of types of dye may be used. Either a single type of coloring material or a combination of two or more types of coloring material may be used.

From the viewpoints of the print density and the ink viscosity, the amount of the coloring material relative to the total mass of the color ink is preferably within a range from 0.1 to 20% by mass, more preferably from 1 to 15% by mass, and even more preferably from 2 to 7% by mass.

In those cases where a pigment is used as the coloring material in the color ink, a pigment dispersant typified by polymer dispersants and surfactant-type dispersants and the like may be used to ensure stable dispersion of the pigment in the color ink. Pigment dispersants selected from among those described above in relation to the white ink may be used as the pigment dispersant.

When used, there are no particular limitations on the blend amount of the pigment dispersant in the color ink, which varies depending on the type of pigment dispersant used, but generally, the amount of the pigment dispersant, expressed as a mass ratio of the active ingredient relative to a value of 1 for the pigment, is preferably within a range from 0.005 to 0.5.

The color ink preferably contains water. The color ink may also contain a water-soluble organic solvent, either in addition to the water or instead of the water. Details regarding the water and the water-soluble organic solvent are as described above in relation to the white ink. For example, a water-soluble organic solvent selected from among those described above for the white ink may be used.

From the viewpoint of adjustment of the ink viscosity, the amount of water relative to the total mass of the color ink is preferably within a range from 20% by mass to 80% by mass, and more preferably from 30% by mass to 70% by mass.

The amount of the water-soluble organic solvent, relative to the total mass of the color ink, is preferably within a range from 5 to 50% by mass, and more preferably from 10 to 30% by mass.

Each color ink may also contain a surfactant. For example, a surfactant selected from among those described above in relation to the white ink may be used. Among these, nonionic surfactants are preferred, and acetylene-based surfactants such as acetylene glycol-based surfactants are particularly preferred.

The amount of the surfactant, expressed as an amount of the active ingredient relative to the total mass of the color ink, is preferably within a range from 0.1 to 10% by mass, and more preferably from 0.2 to 5% by mass.

The color ink may also contain a resin such as a water-dispersible resin or a water-soluble resin. For example, by including a fixing resin in the color ink, the fixing properties of the printed image on the fabric and the image coating film strength can be further enhanced. From the viewpoints of achieving jetting characteristics and a level of storage stability suitable for an inkjet ink, the color ink preferably includes a water-dispersible resin. The water-dispersible resin is preferably blended into the color ink in the form of a water-in-oil emulsion, with the resin able to be dispersed in the color ink in the form of resin particles. Examples of water-soluble resins that may be used include resins selected from among those described above in relation to the white ink, and for example, a water-dispersible urethane resin, another type of water-dispersible resin, or a combination thereof may be used.

The amount of the water-dispersible resin, relative to the total mass of the color ink, is preferably within a range from 1 to 30% by mass, more preferably from 3 to 30% by mass, and even more preferably from 5 to 20% by mass.

The color ink may also contain a crosslinking agent. By including a crosslinking agent in the color ink, the image coating film strength can be further improved. By enhancing the coating film strength, cracking of the image following washing of the printed textile item can be better suppressed. Examples of the crosslinking agent include carbodiimide-based compounds, isocyanate-based compounds, and oxazoline-based compounds.

The amount of the crosslinking agent, relative to the total mass of the color ink, is preferably within a range from 0.1 to 5% by mass, and more preferably from 0.2 to 2% by mass.

The color ink may also contain one or more other components. Examples of these other components include pH adjusters, preservatives, corrosion inhibitors, and antifoaming agents and the like.

There are no particular limitations on the method used for producing the color ink, and production may be performed using appropriate conventional methods. For example, the color ink may be obtained by using a stirring device such as a three-one motor to disperse all of the components, either in a single batch or in a number of separate batches, and then passing the resulting dispersion through a filtration device such as a membrane filter if desired.

From the viewpoint of the ink storage stability, the pH of the color ink is preferably within a range from 7.0 to 10.0, and more preferably from 7.5 to 9.0.

The viscosity of the color ink may be adjusted as appropriate, and for example, from the viewpoint of the jetting characteristics, the viscosity at 23° C. is preferably within a range from 1 to 30 mPa·s.

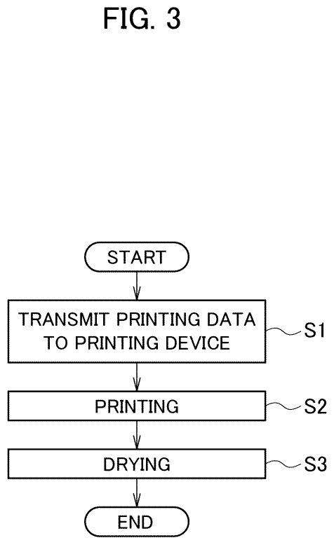

Next is a description of the operation of the printing system 1 with reference to the flowchart of FIG. 3.

The description here relates to operation of the printing system 1 in the case where an image containing a main image and an additional image described above is printed.

In step S1 of FIG. 3, in accordance with a user operation instructing the printing of an image containing a main image and an additional image, the terminal device 3 transmits printing data for printing the image to the printing device 2.

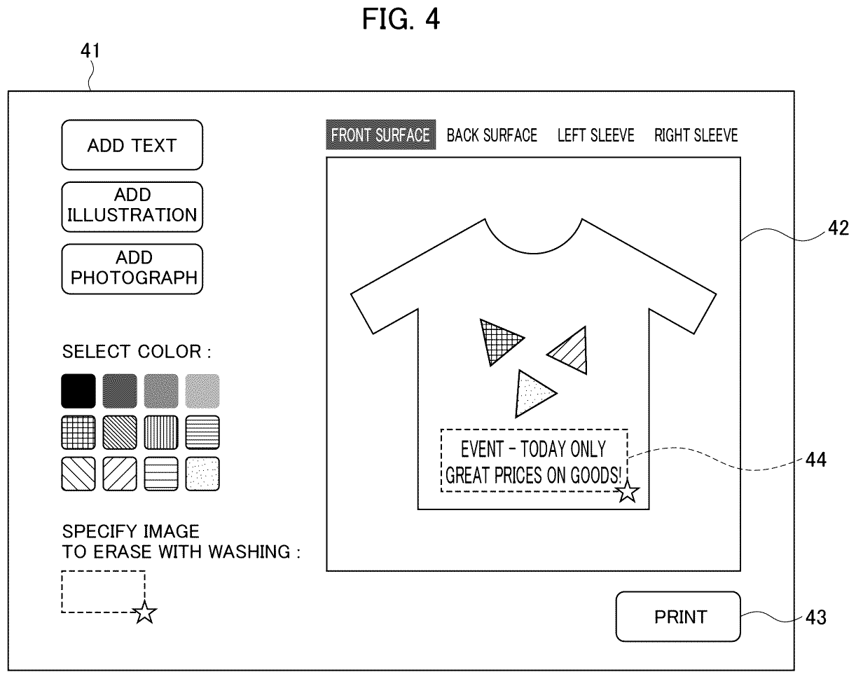

One example of an app screen for giving instructions for printing an image containing a main image and an additional image is shown ion FIG. 4. The app screen 41 illustrated in FIG. 4 is displayed on the display section of the terminal device 3.

As illustrated in FIG. 4, an original image display section 42 which displays the original image destined for printing, and a print button 43 for sending the instruction to print are displayed on the app screen 41.

The user can set the image to be printed as an additional image within the original image displayed by the original image display section 42 by conducting an operation to define a specified area frame 44.

When an image is set using the specified area frame 44 and the print button 43 is then pressed, the terminal device 3 transmits printing data to the printing device 2 for printing an image containing the image set by the specified area frame 44 as the additional image and the remaining image as the main image. The printing data includes information indicating the area of the additional image within the image being printed.

Returning to FIG. 3, in step S2, the control section 14 of the printing device 2 executes printing based on the printing data.

Specifically, the control section 14 first controls the transport section 12 so as to move the fabric installed on the support section to a printing start location. The fabric is installed on the support section of the transport section 12 by user operation or the like.

Next, the control section 14 moves the head unit 21 along the main scanning direction while jetting the pretreatment liquid from the pretreatment liquid jetting head 31 onto the same region as the region on the fabric on which the image based on the printing data is to be formed using the color inks. This completes the jetting operation of the first pass.

Subsequently, the control section 14 uses the transport section 12 to move the fabric backward by a prescribed distance. Then, the control section 14 moves the head unit 21 in the opposite direction from that used during the jetting operation of the previous pass, while jetting the pretreatment liquid from the pretreatment liquid jetting head 31 and jetting the white ink from the white ink jetting head 32.

At this time, the control section 14 jets the white ink onto the same region as the region on the fabric onto which the pretreatment liquid was jetted in the previous pass. The control section 14 controls the jetting of the white ink using a wet-on-wet printing method.

Next, the control section 14 uses the transport section 12 to move the fabric backward by a prescribed distance. Then, the control section 14 moves the head unit 21 in the opposite direction from that used during the jetting operation of the previous pass, while jetting the pretreatment liquid from the pretreatment liquid jetting head 31, jetting the white ink from the white ink jetting head 32, and jetting the color inks from the color ink jetting heads 33 onto the region on the fabric onto which the pretreatment liquid and the white ink were jetted in the preceding passes, thereby forming an image. The control section 14 controls the jetting of the color inks using the wet-on-wet method.

By executing the step of jetting the pretreatment liquid onto the fabric, the step of jetting the white ink onto the region of the fabric on which the pretreatment liquid has been jetted, and the step of jetting the color inks onto the region on which the pretreatment liquid and the white ink have been jetted, while alternately repeating the above movement of the head unit 21 across the main scanning direction and the movement of the fabric in the backward direction, the control section 14 prints the image containing the main image and the additional image.

During this process, as described above, the control section 14 executes the printing of the main image with the weight ratio of the pretreatment liquid relative to the ink adjusted so that the washing fastness of the region of the fabric on which the main image has been printed reaches at least a prescribed first level. Furthermore, the control section 14 executes the printing of the additional image with the weight ratio of the pretreatment liquid relative to the ink adjusted so that the washing fastness of the region of the fabric on which the additional image has been printed is no higher than a prescribed second level that is lower than the first level.

Further, as mentioned above, the first level may be set to represent a change in color in washing fastness as prescribed in JIS L 0844 A-2 of grade 3 or higher, and the second level may be set to a change in color of grade 1.

Further, as mentioned above, the weight ratio of the pretreatment liquid relative to the ink when printing the main image is preferably set to 0.4 or less, and the weight ratio of the pretreatment liquid relative to the ink when printing the additional image is preferably set to 0.55 or greater.

As mentioned above, the washing fastness is mainly dependent on the weight ratio of the pretreatment liquid relative to the ink. On the other hand, for the same weight ratio, a larger amount of ink produces a higher ink coating film strength, and as a result, superior washing fastness. The resin contained in the ink affects the coating film performance, and therefore the greater the amount of ink, the greater the amount of resin contained within the ink resulting in an increase in the ink coating film strength. Further, the greater the amount of the pretreatment liquid, the more likely the ink is to be retained on the surface of the fabric, resulting in improved coloration, but because the adhesion between the fabric and the ink deteriorates, the washing fastness decreases.

Accordingly, during printing of the main image, increasing the amount of ink is effective in improving the washing fastness. On the other hand, in the case of the color inks, once the amount exceeds a certain quantity, increasing the amount of ink may cause dulling of the image and a deterioration in the image quality. In the case of the white ink, the greater the amount of ink, the better the whiteness and concealing properties, which tends to improve the image quality of the image printed with the color inks. Accordingly, when printing the main image, increasing the amount of the white ink rather than the color inks is preferable in terms of enhancing the washing fastness while suppressing any deterioration in the image quality.

Once the printing of the image to the fabric by the printing device 2 has been completed, in step S3, the drying device 4 dries the printed fabric. As a result, a printed textile item composed of the fabric with the formed image is produced. This completes the series of operations.

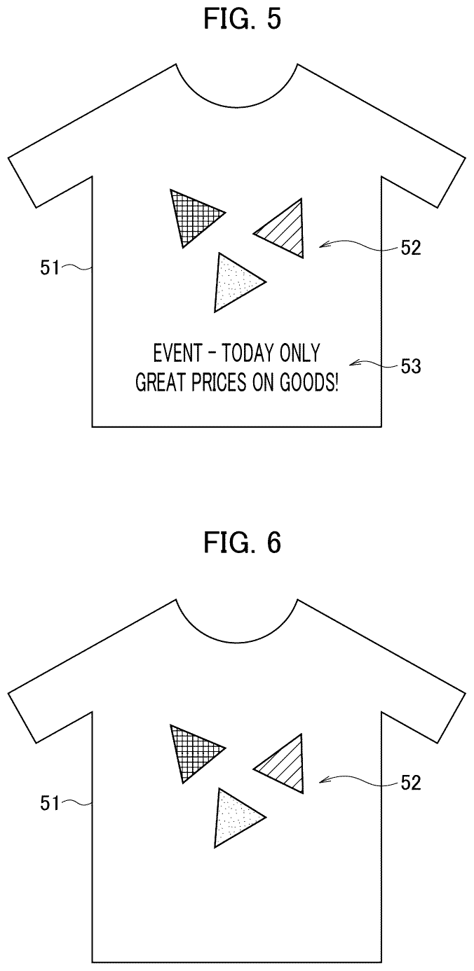

One example of an unwashed fabric item (printed textile item) onto which an image has been printed using the operations described above is shown in FIG. 5. In the example illustrated in FIG. 5, a main image 52 and an additional image 53 are printed on a T-shirt 51 formed from a fabric.

By washing the T-shirt 51 illustrated in FIG. 5 at least once, only the additional image 53 is erased from among the main image 52 and the additional image 53, as illustrated in FIG. 6.

As described above, the control section 14 controls the pretreatment liquid jetting head 31, the white ink jetting head 32 and the color ink jetting heads 33 so that the main image is printed with the weight ratio of the pretreatment liquid relative to the ink adjusted so that the washing fastness of the region of the fabric on which the main image has been printed reaches at least a first level, and the additional image is printed with the weight ratio of the pretreatment liquid relative to the ink adjusted so that the washing fastness of the region of the fabric on which the additional image has been printed is no higher than a prescribed second level that is lower than the first level.

In this manner, by adjusting the weight ratio of the pretreatment liquid relative to the ink, the washing fastness levels of the region of the fabric on which the main image has been printed and the region on which the additional image has been printed can be adjusted without using different types of inks for the main image and the additional image. Accordingly, a printed textile item in which it is possible to erase only an additional image that represents one portion of the printed image can be produced without requiring the use of an additional ink.

The first level described above may be set so that the change in color in washing fastness as prescribed in JIS L 0844 A-2 is grade 3 or higher, and the second level may be set to grade 1. This enables the main image to be printed as an image that does not disappear even upon washing of the fabric, and the additional image to be printed as an image that is erased upon washing of the fabric.

Further, the weight ratio of the pretreatment liquid relative to the ink when printing the main image is preferably 0.4 or lower, and the weight ratio of the pretreatment liquid relative to the ink when printing the additional image is preferably 0.55 or higher. This enables the weight ratio of the pretreatment liquid relative to the ink when printing the main image and the additional image to be set to values that enable the main image to be printed as an image that does not disappear even upon washing of the fabric and the additional image to be printed as an image that is erased upon washing of the fabric.

In the printing of the additional image, jetting of the white ink may be omitted. In such cases, the control section 14 performs control so that the pretreatment liquid is jetted onto the fabric, subsequent jetting of the white ink by the white ink jetting head 32 is omitted, and the color ink jetting heads 33 jets the color inks onto the fabric to print the additional image.

As described above, when printing the main image, increasing the amount of white ink more than the mount of the color ink is preferred in terms of suppressing deterioration in the image quality while improving the washing fastness. In contrast, when printing the additional image, which does not require the same high image quality as the main image and is printed with low washing fastness, jetting of the white ink can be omitted. Omitting the jetting of the white ink can suppress white ink consumption.

Furthermore, in the embodiment described above, the pretreatment liquid and the white ink are jetted onto the same region of the fabric as the region on which the main image is formed with the color inks. However, at least one of the regions onto which the pretreatment liquid is jetted and the region onto which the white ink is jetted may include a portion that differs from the region of the fabric on which the color ink image is formed. Furthermore, the region onto which the pretreatment liquid is jetted may be a broader region than the region onto which the white ink is jetted, which includes the entire region onto which the white ink is jetted.

Further, in the embodiment described above, jetting of the white ink and the color inks was conducted using a wet-on-wet method, but a wet-on-dry method may also be used.

Furthermore, the above embodiment describes the case in which the printing device 2 is a serial inkjet printing device, but an in-line inkjet printing device may also be used. Further, the printed textile item may also be produced using separate devices for jetting the pretreatment liquid and jetting the white ink and color inks.

### Second Embodiment

A second embodiment is described below.

The second embodiment provides a printing system including a printing device which prints image information and post-treatment control information using a pretreatment liquid and an ink, a post-treatment device which reads the post-treatment control information with a reading section, and executes a post-treatment based on the read post-treatment control information, a first printing control section which conducts printing using a ratio between the weights of the pretreatment liquid and the ink that yields a high washing fastness, a second printing control section which conducts printing using a ratio between the weights of the pretreatment liquid and the ink that yields a washing fastness lower than the washing fastness of the first printing control section, and a printing system control section which uses the first printing control section to cause the printing device to conduct printing based on the image information and uses the second printing control section to cause the printing device to print control information for the post-treatment device as the post-treatment control information, causes the reading section to read the printed post-treatment control information, and then controls the post-treatment device based on the read post-treatment control information.

One example of the second embodiment relates to a system including a printing device and a post-treatment device, which uses the image information for the main image described above in the printing device and method for producing a printed textile item according to the first embodiment, uses the post-treatment control information as the additional image, and controls the post-treatment device based on the post-treatment control information. More specifically, this example relates to the technical field described below.

Garment printers that can print to T-shirts and the like are generally well known.

With these garment printers, for example when printing to a T-shirt, not only a printing step, but also a pretreatment step and post-treatment typically exist. In particular, in the post-treatment step, an operation for drying the printed shirt is required, and it is desirable to alter the drying temperature and the drying time and the like in accordance with conditions such as the T-shirt material.

JP 7335625 B discloses technology relating to an on-demand printing service using a garment printer to print to printing targets such as T-shirts, parkers and sweatshirts, wherein printing is conducted based on target information including information relating to the color of the printing target.

JP 6823325 B discloses technology relating to a system which reads identification information from an electronic tag capable of contactless communication in which identification information for identifying a prescribed printing image has been set, specifies a prescribed printing image based on the identification information, and then prints the specified prescribed printing image using a printer.

However, in the technology disclosed in JP 7335625 B and JP 6823325 B, information provision following the printing operation must be recorded each time on a RFID (Radio Frequency Identification) tag or paper form or the like, and there is a possibility that the RFID tag or paper form may be lost. Further, if RFID tags are used, then a large-scale system is required.

In particular, in the case of on-demand printing where the shirt medium may alter for each shirt, control is extremely difficult when the drying time differs for each garment.

Accordingly, if a production control code (number or QR (Quick Response) code (a registered trademark) or the like) is printed onto each shirt, and the desired drying time in the subsequent step is then set by reading this code, then a large system is not required, and the amount of worker time and effort can be reduced.

On the other hand, this production control code is an unnecessary image for the customer, and having this image remain semi-permanently on the T-shirt is not desirable.

The second embodiment has been developed in light of the above circumstances, and has an object of providing a printing system which, with a simple device configuration, conducts printing that enables the erasing of unnecessary control information such as production control codes while retaining necessary information.

A specific configuration of the second embodiment is described below using the drawings.

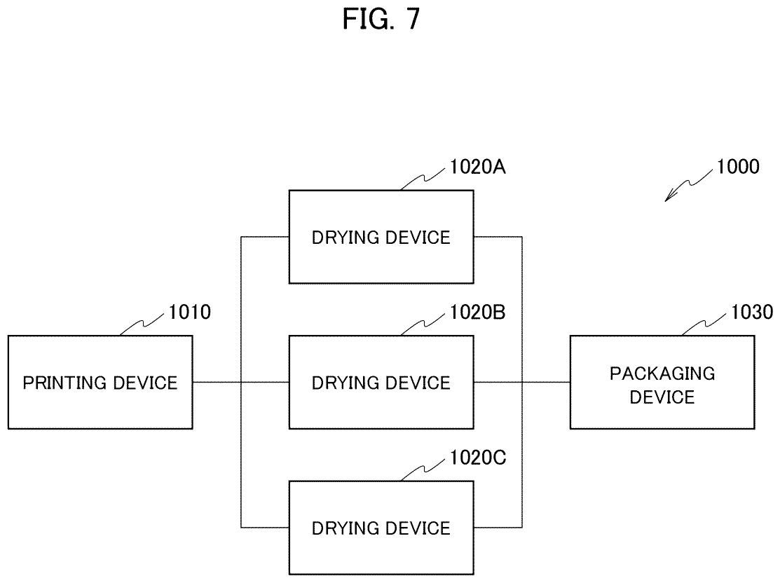

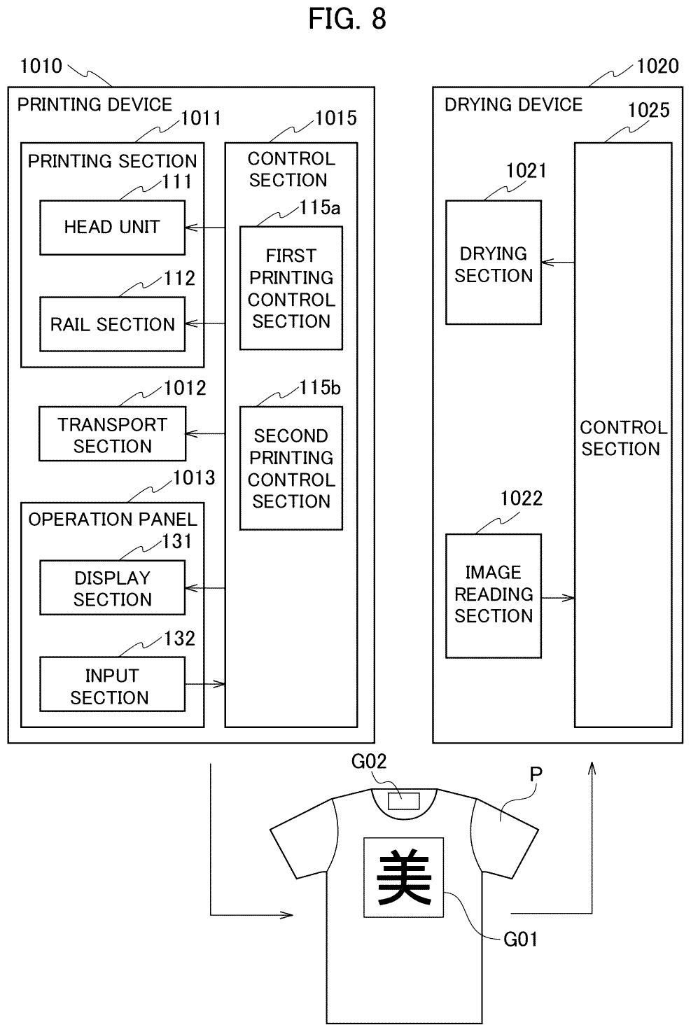

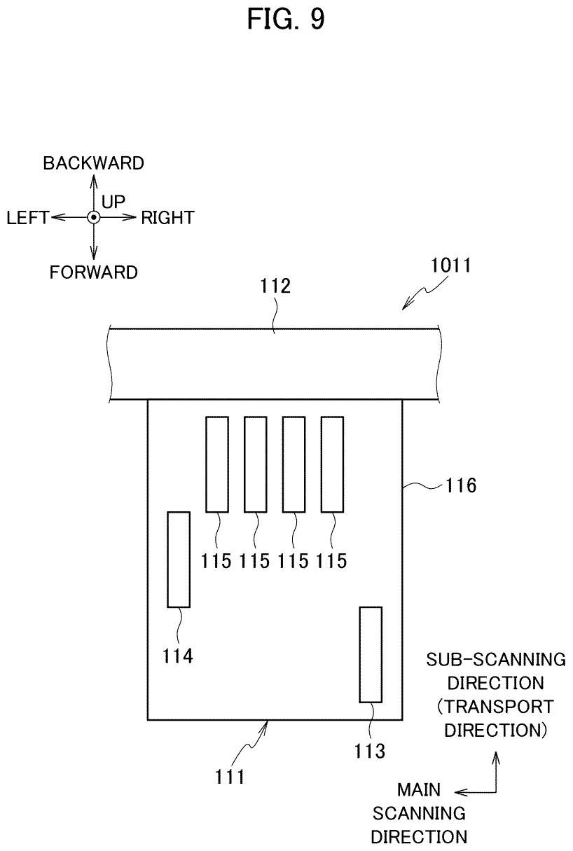

FIG. 7 is an overall structural diagram of a printing system 1000 that represents one example of the second embodiment. FIG. 8 is a schematic illustration of a printing device 1010 and each of the drying devices 1020A to 1020C of the printing system 1000, and FIG. 9 is a schematic illustration of a printing section 1011 of the printing device 1010 illustrated in FIG. 8. In FIG. 9, the direction orthogonal to the surface of the paper is deemed the vertical direction, with the direction extending from the upper surface of the paper indicating the upward direction. Further, the top, bottom, left and right of the paper surface in FIG. 9 indicate the forward, backward, left and right directions respectively.

As illustrated in FIG. 7, the printing system 1000 includes the printing device 1010, the drying devices 1020A to 1020C, and a packaging device 1030.

The printing device 1010 is a garment printer which uses an inkjet printing method to print to a fabric printing medium P such as a T-shirt based on an image (the image information and post-treatment control information and the like described below) acquired from a computer via a network (not shown in the drawings).

The drying devices 1020A to 1020C are an example of post-treatment devices, and are dryers such as hot air dryers, IR dryers, heat presses, or warm air dryers. The drying devices 1020A to 1020C read the post-treatment control information, and execute a drying treatment based on the read post-treatment control information. The post-treatment control information includes a job ID, and the drying conditions (drying temperature, drying team, air flow, press pressure and the like).

The drying treatment is preferably conducted with appropriate altering of the drying temperature and the drying time and the like in accordance with conditions such as the material of the printing medium. However, because changing the temperature of the drying treatment takes time, the drying devices 1020A to 1020C are each set to a different drying temperature. The drying devices 1020A to 1020C are provided in parallel, and therefore without conducting any alteration of drying temperature, the printing medium P can be simply transported to the drying device among the drying devices 1020A to 1020C which matches the drying temperature included in the post-treatment control information, with the drying treatment then conducted in the chosen drying device. The above description describes an example in which a plurality of drying devices are installed, but in cases where installation space is limited, a single drying device having a heater capable of altering the temperature comparatively quickly may be installed, with the drying conditions then set as appropriate. The packaging device 1030 folds the printing medium P that has been dried in the drying device 1020A to 1020C and then packages the printing medium in accordance with the job ID, enabling production of printing media P of each job ID.

As illustrated in FIG. 8, the printing device 1010 includes a printing section 1011, a transport section 1012, an operation panel 1013, and a control section 1015.

The printing section 1011 conducts printing to the fabric printing medium P using an inkjet method. The printing section 1011 contains a head unit 111 and a rail section 112.

Examples of the fabric include natural fibers such as cotton, silk, wool and linen; chemical fibers such as polyester, acrylic, polyurethane, nylon, rayon, cupra and acetate; and mixed spun fibers of these fibers. Further, the fabric may be a woven fabric, a knitted fabric, or a nonwoven fabric or the like.

The head unit 111 conducts printing by jetting a pretreatment liquid, a white ink and color inks onto the fabric. The head unit 111 includes a pretreatment liquid jetting head 113, a white ink jetting head 114, a plurality of color ink jetting heads 115, and a head holder 116. Details regarding the pretreatment liquid, the white ink, and the color inks are described below.

The pretreatment liquid jetting head 113 jets a pretreatment liquid. The pretreatment liquid jetting head 113 opens at the lower surface (the jetting surface), and has a plurality of nozzles (not shown in the drawing) aligned along the forward-backward direction (the sub-scanning direction), with the pretreatment liquid being jetted from these nozzles. Details of the pretreatment liquid are described below.

The white ink jetting head 114 jets a white ink. The white ink jetting head 114 has a similar structure to the pretreatment liquid jetting head 113, with the exception that the jetted liquid is different. The white ink jetting head 114 is disposed backward of the pretreatment liquid jetting head 113 in the forward-backward direction (the sub-scanning direction). Details of the white ink are described below.

The color ink jetting heads 115 jet color inks. In the case of the second embodiment, four color ink jetting heads 115 are provided which jet black, cyan, magenta and yellow inks respectively. The color ink jetting heads 115 have a similar structure to the pretreatment liquid jetting head 113, with the exception that the jetted liquid is different. The four color ink jetting heads 115 are disposed backward of the white ink jetting head 114 in the forward-backward direction (the sub-scanning direction). The four color ink jetting heads 115 are aligned across the left-right direction (the main scanning direction). Details of the color inks are described below.

The head holder 116 holds the pretreatment liquid jetting head 113, the white ink jetting head 114, and the four color ink jetting heads 115.

The rail section 112 moves the head unit 111 back and forth across the left-right direction (the main scanning direction).

The transport section 102 has a holding section (not shown in the drawing) that holds the fabric, and transports the fabric held by the holding section in a transport direction (the sub-scanning direction) from the forward side toward the backward side beneath the head unit 111.

The operation panel 1013 receives input operations from the user, and displays various screen images. The operation panel 1013 includes a display section 131 and an input section 132. The display section 131 displays various screen images. The display section 131 has a liquid crystal display panel or the like. The input section 132 receives input operations from the user, and outputs operating signals in accordance with those operations. The input section 132 has any of various operating keys or a touch panel or the like.

The control section 1015 controls the overall operation of the printing device 1010. The control section 1015 is constructed from a CPU, RAM, ROM, and a hard disk and the like. The control section 1015 conducts printing to a printing medium P by jetting the pretreatment liquid, the white ink and the color inks onto the printing medium P such as a T-shirt based on the image information and the post-treatment control information.

In order to achieve that functionality, the control section 1015 includes a first printing control section 115a and a second printing control section 115b, and switches control between the first printing control section 115a and the second printing control section 115b in accordance with the target image being printed. Specifically, the control section 1015 conducts printing such that the first printing control section 115a prints to the printing section 1011 based on the image information, and the second printing control section 115b prints control information for the drying device 1020 to the printing section 1011 as the post-treatment control information.

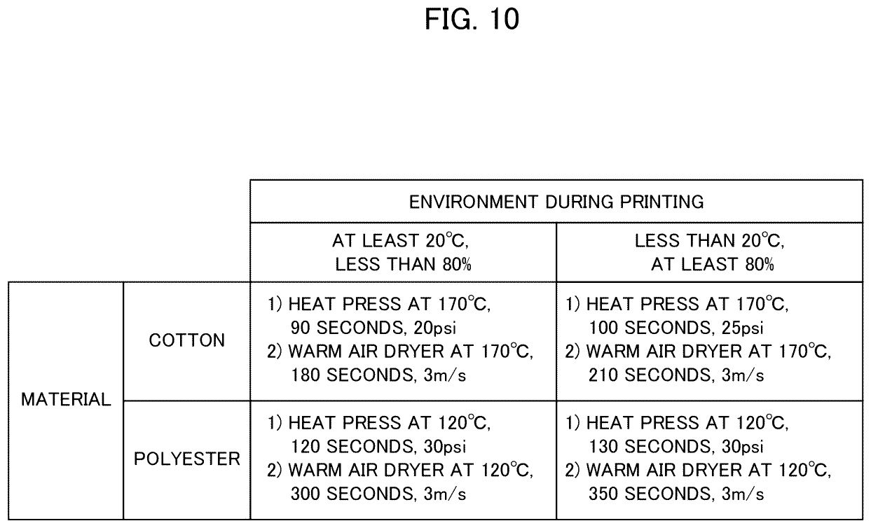

FIG. 10 is an explanatory diagram illustrating one example of the setting content of the post-treatment control information in the printing system 1000.

As illustrated in FIG. 10, the information embedded in the post-treatment control information is altered depending on the environment during printing, the material of the printing medium P (cotton or polyester), and the type of dryer (heat press or warm air dryer).

For example, in the case where the environment during printing includes a temperature of at least 20° C. but less than 80° C., and a heat press is used for printing to cotton, the drying conditions are set to a drying temperature of 170° C., a drying time of 90 seconds, and a press pressure of 20 psi. Further, in the case where the environment during printing includes a temperature of at least 20° C. but less than 80° C., and a warm air dryer is used for printing to cotton, the drying conditions are set to a drying temperature of 170° C., a drying time of 180 seconds, and an air flow rate of 3 m/s.

The control section 1015 determines the setting content (drying conditions) based on the setting content illustrated in FIG. 10, the environment during printing, the material of the printing medium P being printed, and the type of dryer being used, and embeds the setting content in the post-treatment control information. Specifically, the control section 1015 converts the setting content (drying conditions) into an identification code such as a barcode (a registered trademark).

The first printing control section 115a prints the pretreatment liquid and the ink from the head unit 111 using a weight ratio between the pretreatment liquid and the ink that ensures improved washing fastness. Here, the white ink and the color inks are jointly referred to as simply ink”.

The second printing control section 115b prints the pretreatment liquid and the inks from the head unit 111 using a weight ratio between the pretreatment liquid and the ink that yields a washing fastness lower than that achieved with the first printing control section 115a.

Here, the washing fastness is an indicator representing resistance to color fading or color migration of a dyed fabric, and the washing fastness achieved by the first printing control section 115a is deemed to represent a change in color in accordance with JIS L 0844 A-2 of grade 3 or higher, whereas the washing fastness achieved by the second printing control section 115b is deemed to represent a change in color in accordance with JIS L 0844 A-2 of grade 1.

More specifically, the weight ratio of the coating amount of the pretreatment liquid relative to the coating amount of the inks (the white ink and the color inks) is set to 0.4 or lower for the first printing control section 115a, and 0.55 or higher for the second printing control section 115b.

As a result, a printing medium P on which image information G01 and post-treatment control information G02 have been printed can be obtained. The image information G01 is printed using the first printing control section 115a, and therefore has high washing fastness, and is resistant to color fading or color migration even upon washing. In contrast, the post-treatment control information G02 is an unnecessary image for the customer, and it is desirable that this image is not retained semi-permanently on the printing medium P. Accordingly, by printing the post-treatment control information G02 using the second printing control section 115b, the washing fastness is low, and the image fades readily upon washing.

The drying devices 1020A to 1020C each include a drying section 1021, an image reading section 1022, and a control section 1025.

The drying section 1021 is a dryer such as a hot air dryer, IR dryer, heat press, or warm air dryer, and is used for drying the printing medium P that has been printed by the printing device 1010.

The image reading section 1022 reads the post-treatment control information G02 printed on the printing medium P.

The control section 1025 controls the overall operation of the drying device 1020. The control section 1025 is constructed from a CPU, RAM, ROM, and a hard disk and the like. The control section 1025 instructs the image reading section 1022 to read the post-treatment control information printed on the printing medium P, and then controls the drying section 1021 based on the read post-treatment control information. In the printing system 1000 illustrated in the drawings, the control section 1015 of the printing device 1010 and the control section 1025 of the drying device 1020 are provided separately, but these control sections may also be combined into a single section.

The post-treatment control information is printed with low washing fastness using the second printing control section 115b, and therefore after being read, fades upon washing, meaning it disappears and is not retained as unsightly information for the customer.

Here, each of the drying devices 1020A to 1020C was described as having a drying section 1021, an image reading section 1022 and a control section 1025, but the discloser is not limited to this configuration, and a single image reading section 1022 may be provided for the drying devices 1020A to 1020C, with this image reading section 1022 being connected electrically to the drying devices 1020A to 1020C which each include a drying section 1021 and a control section 1025. In this case, the post-treatment control information read by the image reading section 1022 may be transmitted to the control section 1025 of the drying device among the drying devices 1020A to 1020C that employs drying conditions matching those indicated by the post-treatment control information.

In this description, the drying devices 1020A to 1020C have been described as one example of a post-treatment device, but the post-treatment device is not limited to a drying device, and any device may be used for which it is desirable to alter control in accordance with the printing medium P that has been printed by the printing device 1010.

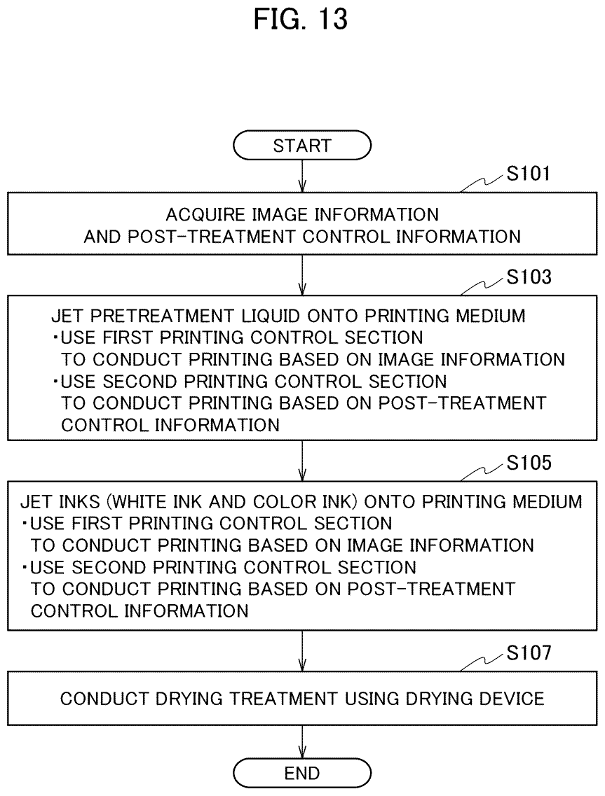

FIG. 13 is a flowchart illustrating the processing content in the printing system 1000.

As illustrated in FIG. 13, in step S101, the printing device 1010 acquires image information and post-treatment control information from a computer via the network.

In step S103, the printing device 1010 jets the pretreatment liquid onto the printing medium P. Specifically, the control section 1015 of the printing device 1010 uses the first printing control section 115a to jet the pretreatment liquid from the pretreatment liquid jetting head 113 of the printing section 1011 based on the image information, in a jetting amount that yields a ratio between the weights of the pretreatment liquid and the ink that causes an increase in the washing fastness. Further, the control section 1015 of the printing device 1010 uses the second printing control section 115b to jet the pretreatment liquid from the pretreatment liquid jetting head 113 of the printing section 1011 based on the post-treatment control information, in a jetting amount that yields a ratio between the weights of the pretreatment liquid and the ink that causes a reduction in the washing fastness.

In step S105, the printing device 1010 jets the ink (the white ink and the color inks) onto the printing medium P. Specifically, the control section 1015 of the printing device 1010 uses the first printing control section 115a to jet the white ink from the white ink jetting head 114 of the printing section 1011 based on the image information, in a jetting amount that yields a ratio between the weights of the pretreatment liquid and the ink that causes an increase in the washing fastness, and uses the first printing control section 115a to jet the color inks from the color ink jetting heads 115 of the printing section 1011 based on the image information, in jetting amounts that yield a ratio between the weights of the pretreatment liquid and the ink that causes an increase in the washing fastness.

Furthermore, the control section 1015 of the printing device 1010 uses the second printing control section 115b to jet the white ink from the white ink jetting head 114 of the printing section 1011 based on the post-treatment control information, in a jetting amount that yields a ratio between the weights of the pretreatment liquid and the ink that causes a reduction in the washing fastness, and uses the second printing control section 115b to jet the color inks from the color ink jetting heads 115 of the printing section 1011 based on the post-treatment control information, in jetting amounts that yield a ratio between the weights of the pretreatment liquid and the ink that causes a reduction in the washing fastness.

In step S107, one of the drying devices 1020A to 1020C executes a drying treatment by using the image reading section 1022 to read the post-treatment control information printed on the printing medium P, and then controlling the drying section 1021 based on the read post-treatment control information.

In this manner, by employing the printing system 1000 according to one of the embodiments, the printing device 1010 uses the first printing control section 115a to conduct printing from the head unit 111 based on the image information, using a ratio between the weights of the pretreatment liquid and the ink that causes an increase in the washing fastness, and uses the second printing control section 115b to conduct printing from the head unit 111 based on the post-treatment control information, using a ratio between the weights of the pretreatment liquid and the ink that yields a lower washing fastness than that achieved by the first printing control section 115a, and the drying device 1020 then uses the image reading section 1022 to read the post-treatment control information printed on the printing medium P, and controls the drying section 1021 based on the read post-treatment control information.

As a result, image information which has high washing fastness and is resistant to color fading or color migration even upon washing, and post-treatment control information which has low washing fastness and disappears readily when washed can be printed with no alteration of the hardware configuration. Accordingly, printing which enables post-treatment control information that is unnecessary to the customer to be erased while retaining only the necessary information (image information) can be conducted with a simple device configuration.

The second embodiment has been described above, but it should be noted that aspects of the first embodiment described above may be additionally applied to those aspects of the second embodiment for which no description has been provided above, or used instead of aspects of the second embodiment described above.

The present disclosure is not limited to the embodiments as described above, and variations of the constituent elements may be implemented at the time of use provided they do not depart from the scope of the present disclosure. Further, various inventions can be formed by appropriate combination of a plurality of constituent elements disclosed in the above embodiments. For example, a number of constituent elements may be omitted from among all the constituent elements disclosed in one of the embodiments.

The disclosure discloses the following embodiments.

[1] A printing device including:
a pretreatment liquid jetting section which jets a pretreatment liquid that causes ink coagulation,
an ink jetting section which jets an ink, and
a control section which performs control such that the pretreatment liquid jetting section jets the pretreatment liquid onto a fabric, and the ink jetting section jets the ink onto the fabric onto which the pretreatment liquid has been jetted, thereby printing a main image and an additional image, wherein
the control section controls the pretreatment liquid jetting section and the ink jetting section such that the main image is printed with the weight ratio of the pretreatment liquid relative to the ink adjusted so that the washing fastness of the region of the fabric on which the main image has been printed reaches at least a prescribed first level, and the additional image is printed with the weight ratio of the pretreatment liquid relative to the ink adjusted so that the washing fastness of the region of the fabric on which the additional image has been printed is no higher than a prescribed second level that is lower than the first level.

[2] The printing device according to [1], wherein
the first level represents a change in color in washing fastness as prescribed in JIS L 0844 A-2 of grade 3 or higher, and
the second level represents a change in color in washing fastness as prescribed in JIS L 0844 A-2 of grade 1.

[3] The printing device according to [1], wherein the control section sets the weight ratio of the pretreatment liquid relative to the ink when printing the main image to 0.4 or lower, and sets the weight ratio of the pretreatment liquid relative to the ink when printing the additional image to 0.55 or higher.

[4] The printing device according to [1], wherein
the first level represents a change in color in washing fastness as prescribed in JIS L 0844 A-2 of grade 3 or higher,
the second level represents a change in color in washing fastness as prescribed in JIS L 0844 A-2 of grade 1, and
the control section sets the weight ratio of the pretreatment liquid relative to the ink when printing the main image to 0.4 or lower, and sets the weight ratio of the pretreatment liquid relative to the ink when printing the additional image to 0.55 or higher.

[5] The printing device according to [1], wherein
the ink jetting section has a white ink jetting section that jets a white ink, and a color ink jetting section that jets a color ink, and
the control section performs control so that
the main image is printed by the white ink jetting section jetting the white ink onto the fabric onto which the pretreatment liquid has been jetted, and the color ink jetting section jetting the color ink onto the fabric onto which the pretreatment liquid and the white ink have been jetted, and
the additional image is printed by omitting jetting of the white ink by the white ink jetting section, and the color ink jetting section jetting the color ink onto the fabric onto which the pretreatment liquid has been jetted.

[6] The printing device according to [5], wherein
the first level represents a change in color in washing fastness as prescribed in JIS L 0844 A-2 of grade 3 or higher,
the second level represents a change in color in washing fastness as prescribed in JIS L 0844 A-2 of grade 1, and
the control section sets the weight ratio of the pretreatment liquid relative to the ink when printing the main image to 0.4 or lower, and sets the weight ratio of the pretreatment liquid relative to the ink when printing the additional image to 0.55 or higher.

[7] The printing device according to [1], wherein
the control section sets the amount of ink used in printing the main image to a larger amount than the amount of ink used in printing the additional image.

[8] The printing device according to [1], wherein
the ink jetting section has a white ink jetting section that jets a white ink, and a color ink jetting section that jets a color ink,
the control section performs control so that
the main image is printed by the white ink jetting section jetting the white ink onto the fabric onto which the pretreatment liquid has been jetted, and the color ink jetting section jetting the color ink onto the fabric onto which the pretreatment liquid and the white ink have been jetted, and
the additional image is printed by the white ink jetting section jetting the white ink onto the fabric onto which the pretreatment liquid has been jetted, and the color ink jetting section jetting the color ink onto the fabric onto which the pretreatment liquid and the white ink have been jetted, and
the amount of white ink used in printing the main image is set to a larger amount than the amount of white ink used in printing the additional image.

[9] The printing device according to [8], wherein
the first level represents a change in color in washing fastness as prescribed in JIS L 0844 A-2 of grade 3 or higher,
the second level represents a change in color in washing fastness as prescribed in JIS L 0844 A-2 of grade 1, and
the control section sets the weight ratio of the pretreatment liquid relative to the ink when printing the main image to 0.4 or lower, and sets the weight ratio of the pretreatment liquid relative to the ink when printing the additional image to 0.55 or higher.

[10] The printing device according to [1], wherein
printing is conducted so that the main image is retained but the additional image undergoes relative disappearance upon washing of the fabric.

[11] A method for producing a printed textile item, the method including:
a step of printing a main image by jetting a pretreatment liquid that causes ink coagulation onto a fabric, and then jetting an ink onto the fabric onto which the pretreatment liquid has been jetted, and
a step of printing an additional image by jetting the pretreatment liquid onto the fabric, and then jetting an ink onto the fabric onto which the pretreatment liquid has been jetted, wherein
in the step of printing the main image, the main image is printed with the weight ratio of the pretreatment liquid relative to the ink adjusted so that the washing fastness of the region of the fabric on which the main image has been printed reaches at least a prescribed first level, and
in the step of printing the additional image, the additional image is printed with the weight ratio of the pretreatment liquid relative to the ink adjusted so that the washing fastness of the region of the fabric on which the additional image has been printed is no higher than a prescribed second level that is lower than the first level.

[12] A printing system including:
a printing device which prints image information and post-treatment control information using a pretreatment liquid and an ink,
a post-treatment device which reads the post-treatment control information with a reading section, and executes a post-treatment based on the read post-treatment control information,
a first printing control section which conducts printing using a ratio between the weights of the pretreatment liquid and the ink that yields a high washing fastness,
a second printing control section which conducts printing using a ratio between the weights of the pretreatment liquid and the ink that yields a washing fastness lower than the washing fastness of the first printing control section, and
a printing system control section which uses the first printing control section to cause the printing device to conduct printing based on the image information and uses the second printing control section to cause the printing device to print control information for the post-treatment device as the post-treatment control information, causes the reading section to read the printed post-treatment control information, and then controls the post-treatment device based on the read post-treatment control information.

[13] The printing system according to [12], wherein
the washing fastness achieved by the first printing control section represents a change in color as prescribed in JIS L 0844 A-2 of grade 3 or higher, and the washing fastness achieved by the second printing control section represents a change in color as prescribed in JIS L 0844 A-2 of grade 1.

[14] The printing system according to [12], wherein
the weight ratio of the coating amount of the pretreatment liquid relative to the coating amount of the ink is set to 0.4 or less for the first printing control section, and set to 0.55 or higher for the second printing control section.

[15] The printing system according to [12], wherein the post-treatment device is a drying device for drying the pretreatment liquid and the ink used in the printing device.

[16] The printing system according to [12], wherein
the washing fastness achieved by the first printing control section represents a change in color as prescribed in JIS L 0844 A-2 of grade 3 or higher,
the washing fastness achieved by the second printing control section represents a change in color as prescribed in JIS L 0844 A-2 of grade 1, and
the weight ratio of the coating amount of the pretreatment liquid relative to the coating amount of the ink is set to 0.4 or less for the first printing control section, and set to 0.55 or higher for the second printing control section.

[17] The printing system according to [12], wherein

the washing fastness achieved by the first printing control section represents a change in color as prescribed in JIS L 0844 A-2 of grade 3 or higher,
the washing fastness achieved by the second printing control section represents a change in color as prescribed in JIS L 0844 A-2 of grade 1,
the weight ratio of the coating amount of the pretreatment liquid relative to the coating amount of the ink is set to 0.4 or less for the first printing control section, and set to 0.55 or higher for the second printing control section, and
the post-treatment device is a drying device for drying the pretreatment liquid and the ink used in the printing device.

[18] The printing system according to [12], wherein
the post-treatment device includes a plurality of post-treatment devices for executing the post-treatment under different conditions, and
the printing system control section, based on the read post-treatment control information, executes the post-treatment using the post-treatment device selected from among the plurality of post-treatment devices that matches the post-treatment conditions.

[19] The printing system according to [12], wherein
the post-treatment device includes a drying device for drying the pretreatment liquid and the ink used by the printing device,
the drying device has a plurality of drying devices that implement drying at different drying temperatures, and
the printing system control section executes the post-treatment based on the read post-treatment control information, using the drying device among the plurality of drying devices that matches the post-treatment conditions.

The various aspects disclosed above in [1] to [19] may each be implemented alone, or two aspects may be combined.

### EXAMPLES

The present disclosure is described below in further detail using a series of examples. However, the present disclosure is not limited to the following examples.

### Test Example 1

A Test Example 1 relating mainly to the first embodiment is described below.

### <Production of Pretreatment Liquid>

The raw materials for a pretreatment liquid are shown in Table 1. In those cases where a raw material includes a solvent or the like, the blend proportion of the raw material shown in Table 1 includes that solvent or the like.

The raw materials were mixed in the blend proportions shown in Table 1 to obtain the pretreatment liquid.

TABLE 1

| | | Pretreatment |
|---|---|---|
| Units: % by mass | | liquid |
| Coagulant | Calcium chloride | 15 |
| Water-soluble solvent | Dipropylene glycol | 23.5 |
| Surfactant | OLFINE E1010 | 0.8 |
| Water | Ion-exchanged water | 60.7 |
| Total (% by mass) | | 100 |

### <Production of White Ink>

The raw materials for a white ink are shown in Table 2. In those cases where a raw material includes a solvent or the like, the blend proportion of the raw material shown in Table 2 includes that solvent or the like.

The raw materials were mixed in the blend proportions shown in Table 2, and the mixture was then filtered through a membrane filter with a pore diameter of 3 μm to obtain the white ink.

TABLE 2

| | | Active | White |
|---|---|---|---|
| Units: % by mass | | ingredient | ink |
| Pigment dispersion | White pigment dispersion | 35% | 28 |
| Resin emulsions | SUPERFLEX 470 | 38% | 26 |
| | ELITEL KT9204 | 30% | 20 |
| Water-soluble solvents | Glycerol | | 5 |
| | Diethylene glycol | | 15 |
| Surfactant | OLFINE E1010 | | 0.5 |
| Water | Ion-exchanged water | | 5.5 |
| Total (% by mass) | | | 100 |

The white pigment dispersion listed in Table 2 was obtained using the method described below.

### (Production of White Pigment Dispersion)

First, 350 g of titanium oxide TIPAQUE R-980 (manufactured by Ishihara Sangyo Kaisha, Ltd.) as a white pigment, and 17.5 g (active ingredient: 3.5 g) of DEMOL P (manufactured by Kao Corporation) as a pigment dispersant were mixed with 632.5 g of ion-exchanged water, and a beads mill (DYNO-MILL KDL model A, manufactured by Shinmaru Enterprises Corporation) containing 0.5 mmø zirconia beads at a fill ratio of 80% was used to disperse the mixture under conditions including a residence time of 2 minutes, thus obtaining a pigment dispersion (pigment fraction: 35% by mass). This dispersion was used as the white pigment dispersion.

### <Production of Color Ink>

The raw materials for a color ink are shown in Table 3. In those cases where a raw material includes a solvent or the like, the blend proportion of the raw material shown in Table 1 includes that solvent or the like. In this case, a cyan ink was used as the color ink.

The raw materials were mixed in the blend proportions shown in Table 3, and the mixture was then filtered through a membrane filter with a pore diameter of 3 μm to obtain the color ink.

TABLE 3

| | | Active | Color |
|---|---|---|---|
| Unis: % by mass | | ingredient | ink |
| Pigment dispersion | CAB-O-JET 450C | 15% | 33.3 |
| Resin emulsion | SUPERFLEX 470 | 38% | 26.3 |
| Water-soluble solvents | Glycerol | | 15 |
| | Diethylene glycol | | 15 |
| Surfactant | OLFINE E1010 | | 0.5 |
| Water | Ion-exchanged water | | 9.9 |
| Total (% by mass) | | | 100 |

### <Production of Printed Textile Items>

Using the pretreatment liquid, the white ink and the color ink (cyan ink) produced using the methods described above, printed textile items of Examples 1 to 6 and a Comparative Example were produced in the manner described below.

Using an inkjet printer MMP-8130 manufactured by Mastermind Inc., the pretreatment liquid, the white ink and the color ink were jetted in that order onto two regions A and B of a fabric to print an image of the Japanese kanji character illustrated in the FIG. 2, which means “beautiful”, in Meiryo font at point size 36.

In each of Examples 1 to 6 and the Comparative Example, the jetted amount of ink (color ink+white ink), the jetted amount of color ink, the jetted amount of white ink, and the weight ratio of the pretreatment liquid relative to the ink in each of the regions A and B were as shown in Tables 4 to 6. In the region B of Example 4, jetting of the white ink was omitted (namely, the jetted amount of white ink was zero).

The materials of the fabrics used in Examples 1 to 6 and the Comparative Example were as shown in Tables 4 to 6.

In Examples 1, 4 and 5 in which the material of the fabric was cotton, the printed fabric was dried at 170° C. for 90 seconds using a heat press to obtain the printed textile item. In Examples 2, 3 and 6 and the Comparative Example in which the material of the fabric was polyester, the printed fabric was dried at 120° C. for 120 seconds using a heat press to obtain the printed textile item.

### <Evaluation of Washing Fastness>

The washing fastness of the printed textile items of Examples 1 to 6 and the Comparative Example was determined by evaluating the change in color upon washing in accordance with JIS L 0844 A-2. The results are shown in Tables 4 to 6. The change in color was evaluated across a 9-step scale that included grade 1, grade 1-2, grade 2, grade 2-3, grade 3, grade 3-4, grade 4, grade 4-5, and grade 5, wherein grade 5 represents the highest washing fastness.

TABLE 4

| | | Example 1 | | Example 2 | | Example 3 | |
|---|---|---|---|---|---|---|---|
| | | region A | region B | region A | region B | region A | region B |
| Jetted | Ink (color ink + white ink) | 200 | 200 | 320 | 340 | 20 | 20 |
| amount | Color ink | 20 | 20 | 20 | 20 | 20 | 20 |
| [g/m²] | White ink | 180 | 180 | 300 | 320 | 0 | 0 |
| | Pretreatment liquid | 20 | 120 | 40 | 210 | 3 | 15 |

| Pretreatment liquid / ink (weight ratio) | 0.10 | 0.60 | 0.13 | 0.62 | 0.15 | 0.75 |
|---|---|---|---|---|---|---|
| Material of fabric | Cotton (dark color) | | Polyester (dark color) | | Polyester (light color) | |
| Washing fastness (change in color) | grade 4 | grade 1 | grade 4-5 | grade 1 | grade 3 | grade 1 |

TABLE 5

| | | Example 4 | | Example 5 | | Example 6 | |
|---|---|---|---|---|---|---|---|
| | | region A | region B | region A | region B | region A | region B |
| Jetted | Ink (color ink + white ink) | 200 | 20 | 20 | 20 | 20 | 20 |
| amount | Color ink | 20 | 20 | 20 | 20 | 20 | 20 |
| [g/m²] | White ink | 180 | 0 | 0 | 0 | 0 | 0 |
| | Pretreatment liquid | 20 | 15 | 0 | 15 | 7 | 15 |

| Pretreatment liquid / ink (weight ratio) | 0.01 | 0.75 | 0.00 | 0.75 | 0.35 | 0.75 |
|---|---|---|---|---|---|---|
| Material of fabric | Cotton (light color) | | Cotton (light color) | | Polyester (light color) | |
| Washing fastness (change in color) | grade 4 | grade 1 | grade 3 | grade 1 | grade 3-4 | grade l |

TABLE 6

| | | Comparative Example | |
|---|---|---|---|
| | | region A | region B |
| Jetted | Ink (color ink + white ink) | 20 | 20 |
| amount | Color ink | 20 | 20 |
| [g/m²] | White ink | 0 | 0 |
| | Pretreatment liquid | 10 | 10 |

| Pretreatment liquid / ink (weight ratio) | 0.50 | 0.50 |
|---|---|---|
| Material of fabric | Polyester (light color) | |
| Washing fastness (change in color) | grade 2 | grade 2 |

As illustrated in Tables 4 and 5, in region A in Examples 1 to 6 where the weight ratio of the pretreatment liquid relative to the ink was 0.4 or less, the change in color was grade 3 or higher, and the image of region A had sufficient washing fastness to be considered an image that does not disappear even upon washing.

In contrast, in region A of the Comparative Example in which the weight ratio of the pretreatment liquid relative to the ink exceeded 0.4, the change in color was less than 3, and the image of region A did not achieve sufficient washing fastness to be considered an image that does not disappear even upon washing.

Further, in region B in Examples 1 to 6 where the weight ratio of the pretreatment liquid relative to the ink was 0.55 or higher, the change in color was grade 1, and the image of region B exhibited washing fastness low enough for the image to be considered an image that disappears upon washing.

In contrast, in region B of the Comparative Example in which the weight ratio of the pretreatment liquid relative to the ink was less than 0.55, the change in color exceeded grade 1, and the image of region B did not exhibit washing fastness low enough for the image to be considered an image that disappears upon washing.

### Test Example 2

A Test Example 2 relating mainly to the second embodiment is described below.

### <Production of Pretreatment Liquid>

The raw materials for a pretreatment liquid are shown in Table 2-1. In those cases where a raw material includes a solvent or the like, the blend proportion of the raw material shown in the table includes that solvent or the like.

TABLE 2-1

| | | Pretreatment |
|---|---|---|
| | | liquid 1 |
| Coagulant | Calcium chloride | 15 |
| Water-soluble solvent | Dipropylene glycol | 23.5 |
| Surfactant | OLFINE E1010 | 0.8 |
| Water | Ion-exchanged water | 60.7 |

### <Production of White Ink>

The raw materials for a white ink are shown in Table 2-2. In those cases where a raw material includes a solvent or the like, the blend proportion of the raw material shown in the table includes that solvent or the like.

The raw materials were mixed in the blend proportions shown in the table, and the mixture was then filtered through a membrane filter with a pore diameter of 3 μm to obtain the white ink.

TABLE 2-2

| | | Solid | White |
|---|---|---|---|
| | | fraction | ink |
| Pigment dispersion | White pigment dispersion | 35% | 28 |
| Resin emulsions | SUPERFLEX 470 | 38% | 26 |
| | ELITEL KT9204 | 30% | 20 |
| Water-soluble | Glycerol | | 5 |
| solvents | Diethylene glycol | | 15 |
| Surfactant | OLFINE E1010 | | 0.5 |
| Water | Ion-exchanged water | | 5.5 |

The white pigment dispersion listed in Table 2-2 was obtained using the method described below.

### (Production of White Pigment Dispersion)

First, 350 g of titanium oxide TIPAQUE R-980 (manufactured by Ishihara Sangyo Kaisha, Ltd.) as a white pigment, and 17.5 g (active ingredient: 3.5 g) of DEMOL P (manufactured by Kao Corporation) as a pigment dispersant were mixed with 632.5 g of ion-exchanged water, and a beads mill (DYNO-MILL KDL model A, manufactured by Shinmaru Enterprises Corporation) containing 0.5 mmø zirconia beads at a fill ratio of 80% was used to disperse the mixture under conditions including a residence time of 2 minutes, thus obtaining a pigment dispersion (pigment fraction: 35% by mass). This dispersion was used as the white pigment dispersion.

### <Production of Color Ink>

The raw materials for a color ink are shown in Table 2-3. In those cases where a raw material includes a solvent or the like, the blend proportion of the raw material shown in the table includes that solvent or the like. In this case, a cyan ink was used as the color ink.

The raw materials were mixed in the blend proportions shown in Table 2-3, and the mixture was then filtered through a membrane filter with a pore diameter of 3 μm to obtain the color ink.

TABLE 2-3

| | | Solid | Cyan |
|---|---|---|---|
| | | fraction | ink |
| Pigment dispersion | CAB-O-JET 450C | 15% | 33.3 |
| Resin emulsion | SUPERFLEX 470 | 38% | 26.3 |
| Water-soluble solvents | Glycerol | | 15 |
| | Diethylene glycol | | 15 |
| Surfactant | OLFINE E1010 | | 0.5 |
| Water | Ion-exchanged water | | 9.9 |

Using the above pretreatment liquid, white ink and color ink, printing was conducted using the printing system.

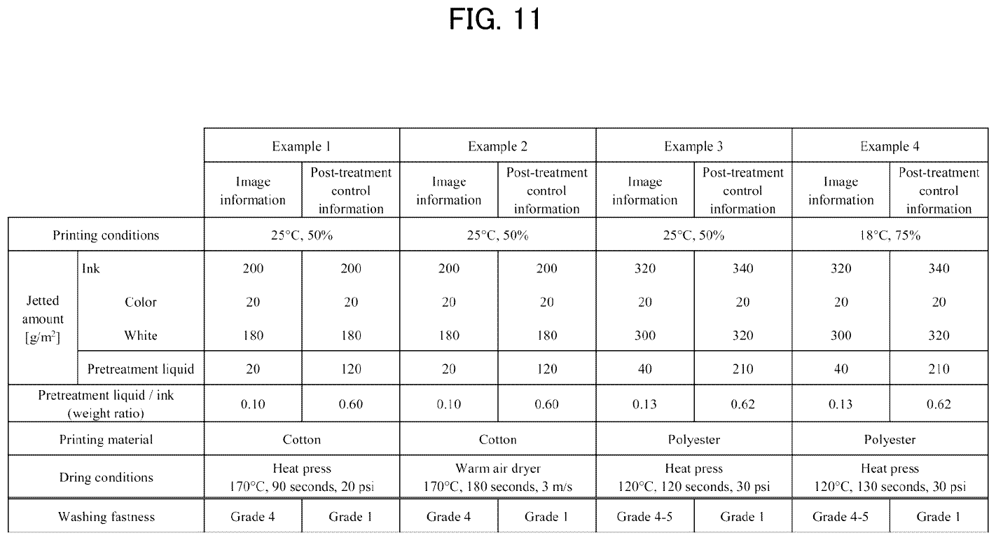

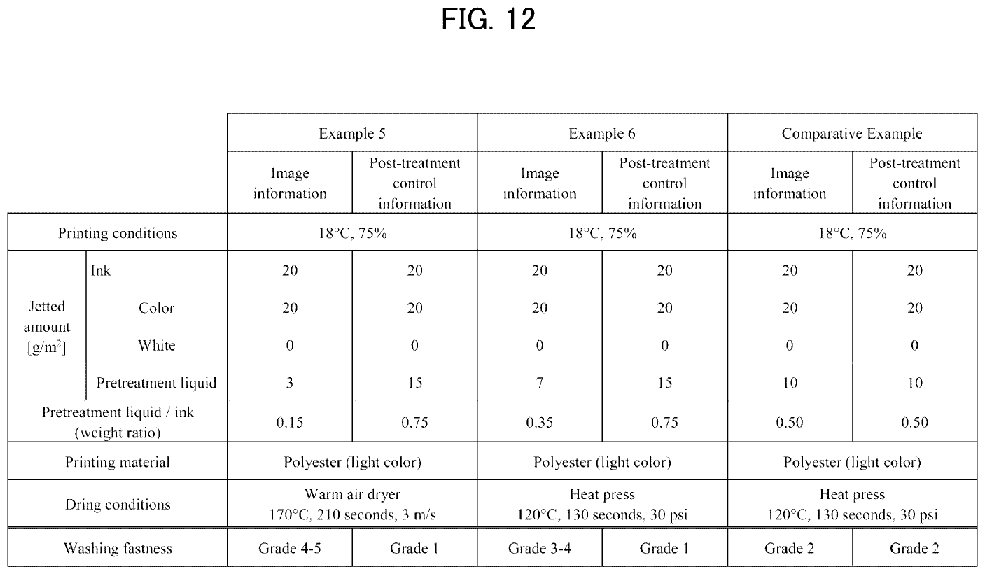

FIG. 11 is a diagram illustrating the evaluation results of evaluating washing fastness in the printing systems of Example 1 to Example 4. FIG. 12 is a diagram illustrating the evaluation results of evaluating washing fastness in the printing systems of Example 5 and Example 6 and the Comparative Example.

FIG. 11 and FIG. 12 show, for each of Example 1 to Example 6, the printing conditions, the jetting amounts for the inks and the pretreatment liquid, the weight ratio of the pretreatment liquid relative to the ink at these jetting amounts, the printing material of the printing medium P undergoing printing, and the washing fastness of the image information and the post-treatment control information when printing and drying were conducted using the drying conditions specified in the post-treatment control information.

As described above, in each of Example 1 to Example 6, the weight ratio of the pretreatment liquid relative to the ink (white ink and color ink) was 0.4 or less for the first printing control section 115a used for printing the image information, and 0.55 or greater for the second printing control section 115b used for printing the post-treatment control information. For example, in Example 1, the value for the first printing control section 115a used for printing the image information was 0.1, and the value for the second printing control section 115b used for printing the post-treatment control information was 0.6.

In terms of the washing fastness, in each of Example 1 to Example 6, the washing fastness achieved by the first printing control section 115a used for printing the image information represents a change in color of grade 3 or higher in JIS L 0844 A-2, whereas the washing fastness achieved by the second printing control section 115b used for printing the post-treatment control information represents a change in color of grade 1 or lower in JIS L 0844 A-2. For example, in Example 1, the washing fastness for the first printing control section 115a used for printing the image information was grade 4, and the washing fastness for the second printing control section 115b used for printing the post-treatment control information was grade 1.

As a result, image information which has high washing fastness and is resistant to color fading or color migration even upon washing, and post-treatment control information which has low washing fastness and disappears readily when washed can be printed with no alteration of the hardware configuration.

In contrast, in the Comparative Example, the washing fastness for the first printing control section 115a used for printing the image information represented a change in color of grade 2, and the washing fastness for the second printing control section 115b used for printing the post-treatment control information also represented a change in color of grade 2. In other words, the Comparative Example does not satisfy the requirement for a washing fastness achieved by the first printing control section 115a that represents a change in color of grade 3 or higher, and a washing fastness achieved by the second printing control section 115b that represents a change in color of grade 1 or lower. As a result, in the Comparative Example, the image information fades more readily than anticipated upon washing, meaning the design which needs to be retained may sometimes disappear. Further, the post-treatment control information is more resistant to fading than anticipated, meaning the image which is unnecessary for the customer may sometimes be retained.

It is to be noted that, besides those already mentioned above, many modifications and variations of the above embodiments may be made without departing from the novel and advantageous features of the present invention. Accordingly, all such modifications and variations are intended to be included within the scope of the appended claims.

### DESCRIPTION OF THE REFERENCE SYMBOLS

1: Printing system, 2: Printing device, 3: Terminal device, 4: Drying device, 11: Printing section, 12: Transport section, 13: Communication section, 14: Control section, 21: Head unit, 22: Rail section, 31: Pretreatment liquid jetting head, 32: White ink jetting head, 33: Color ink jetting head, 34: Head holder, 41: App screen, 42: Original image display section, 43: Print button, 44: Specified area frame, 51: T-shirt, 52: Main image, 53: Additional image,
111: Head unit, 112: Rail section, 113: Pretreatment liquid jetting head, 114: White ink jetting head, 115: Color ink jetting head, 116: Head holder, 131: Display section, 132: Input section, 1000: Printing system, 1010: Printing device, 1011: Printing section, 1012: Transport section, 1013: Operation panel, 1015: Control section, 1020: Drying device, 1021: Drying section, 1022: Image reading section, 1025: Control section, 1030: Packaging device, 1020A: Drying device, 1020B: Drying device, 1020C: Drying device, 115a: First printing control section, 115b: Second printing control section, G01: Image information, G02: Post-treatment control information

What is claimed is:

1. A printing device comprising:
a pretreatment liquid jetting section which jets a pretreatment liquid that causes ink coagulation,
an ink jetting section which jets an ink, and
a control section which performs control such that the pretreatment liquid jetting section jets the pretreatment liquid onto a fabric, and the ink jetting section jets the ink onto the fabric onto which the pretreatment liquid has been jetted, thereby printing a main image and an additional image, wherein
the control section controls the pretreatment liquid jetting section and the ink jetting section such that the main image is printed with a weight ratio of the pretreatment liquid relative to the ink adjusted so that a washing fastness of a region of the fabric on which the main image has been printed reaches at least a prescribed first level, and the additional image is printed with a weight ratio of the pretreatment liquid relative to the ink adjusted so that a washing fastness of a region of the fabric on which the additional image has been printed is no higher than a prescribed second level that is lower than the first level.

2. The printing device according to claim 1, wherein
the first level represents a change in color in washing fastness as prescribed in JIS L 0844 A-2 of grade 3 or higher, and
the second level represents a change in color in washing fastness as prescribed in JIS L 0844 A-2 of grade 1.

3. The printing device according to claim 1, wherein the control section sets the weight ratio of the pretreatment liquid relative to the ink when printing the main image to 0.4 or lower, and sets the weight ratio of the pretreatment liquid relative to the ink when printing the additional image to 0.55 or higher.

4. The printing device according to claim 1, wherein
the first level represents a change in color in washing fastness as prescribed in JIS L 0844 A-2 of grade 3 or higher,
the second level represents a change in color in washing fastness as prescribed in JIS L 0844 A-2 of grade 1, and
the control section sets the weight ratio of the pretreatment liquid relative to the ink when printing the main image to 0.4 or lower, and sets the weight ratio of the pretreatment liquid relative to the ink when printing the additional image to 0.55 or higher.

5. The printing device according to claim 1, wherein
the ink jetting section has a white ink jetting section that jets a white ink, and a color ink jetting section that jets a color ink, and
the control section performs control so that
the main image is printed by the white ink jetting section jetting the white ink onto the fabric onto which the pretreatment liquid has been jetted, and the color ink jetting section jetting the color ink onto the fabric onto which the pretreatment liquid and the white ink have been jetted, and
the additional image is printed by omitting jetting of the white ink by the white ink jetting section, and the color ink jetting section jetting the color ink onto the fabric onto which the pretreatment liquid has been jetted.

6. The printing device according to claim 5, wherein
the first level represents a change in color in washing fastness as prescribed in JIS L 0844 A-2 of grade 3 or higher,
the second level represents a change in color in washing fastness as prescribed in JIS L 0844 A-2 of grade 1, and
the control section sets the weight ratio of the pretreatment liquid relative to the ink when printing the main image to 0.4 or lower, and sets the weight ratio of the pretreatment liquid relative to the ink when printing the additional image to 0.55 or higher.

7. The printing device according to claim 1, wherein
the control section sets an amount of ink used in printing the main image to a larger amount than an amount of ink used in printing the additional image.

8. The printing device according to claim 1, wherein
the ink jetting section has a white ink jetting section that jets a white ink, and a color ink jetting section that jets a color ink,
the control section performs control so that
the main image is printed by the white ink jetting section jetting the white ink onto the fabric onto which the pretreatment liquid has been jetted, and the color ink jetting section jetting the color ink onto the fabric onto which the pretreatment liquid and the white ink have been jetted, and
the additional image is printed by the white ink jetting section jetting the white ink onto the fabric onto which the pretreatment liquid has been jetted, and the color ink jetting section jetting the color ink onto the fabric onto which the pretreatment liquid and the white ink have been jetted, and
an amount of white ink used in printing the main image is set to a larger amount than an amount of white ink used in printing the additional image.

9. The printing device according to claim 8, wherein
the first level represents a change in color in washing fastness as prescribed in JIS L 0844 A-2 of grade 3 or higher,
the second level represents a change in color in washing fastness as prescribed in JIS L 0844 A-2 of grade 1, and
the control section sets the weight ratio of the pretreatment liquid relative to the ink when printing the main image to 0.4 or lower, and sets the weight ratio of the pretreatment liquid relative to the ink when printing the additional image to 0.55 or higher.

10. The printing device according to claim 1, wherein
printing is conducted so that the main image is retained but the additional image undergoes relative disappearance upon washing of the fabric.

11. A method for producing a printed textile item, the method comprising:
a step of printing a main image by jetting a pretreatment liquid that causes ink coagulation onto a fabric, and then jetting an ink onto the fabric onto which the pretreatment liquid has been jetted, and
a step of printing an additional image by jetting the pretreatment liquid onto the fabric, and then jetting an ink onto the fabric onto which the pretreatment liquid has been jetted, wherein
in the step of printing the main image, the main image is printed with a weight ratio of the pretreatment liquid relative to the ink adjusted so that a washing fastness of a region of the fabric on which the main image has been printed reaches at least a prescribed first level, and
in the step of printing the additional image, the additional image is printed with a weight ratio of the pretreatment liquid relative to the ink adjusted so that a washing fastness of a region of the fabric on which the additional image has been printed is no higher than a prescribed second level that is lower than the first level.

12. A printing system comprising:
a printing device which prints image information and post-treatment control information using a pretreatment liquid and an ink,
a post-treatment device which reads the post-treatment control information with a reading section, and executes a post-treatment based on the read post-treatment control information,
a first printing control section which conducts printing using a ratio between weights of the pretreatment liquid and the ink that yields a high washing fastness,
a second printing control section which conducts printing using a ratio between weights of the pretreatment liquid and the ink that yields a washing fastness lower than the washing fastness of the first printing control section, and
a printing system control section which uses the first printing control section to cause the printing device to conduct printing based on the image information and uses the second printing control section to cause the printing device to print control information for the post-treatment device as the post-treatment control information, causes the reading section to read the printed post-treatment control information, and then controls the post-treatment device based on the read post-treatment control information.

13. The printing system according to claim 12, wherein
a washing fastness achieved by the first printing control section represents a change in color as prescribed in JIS L 0844 A-2 of grade 3 or higher, and a washing fastness achieved by the second printing control section represents a change in color as prescribed in JIS L 0844 A-2 of grade 1.

14. The printing system according to claim 12, wherein
a weight ratio of a coating amount of the pretreatment liquid relative to a coating amount of the ink is set to 0.4 or less for the first printing control section, and set to 0.55 or higher for the second printing control section.

15. The printing system according to claim 12, wherein the post-treatment device is a drying device for drying the pretreatment liquid and the ink used in the printing device.

16. The printing system according to claim 12, wherein
a washing fastness achieved by the first printing control section represents a change in color as prescribed in JIS L 0844 A-2 of grade 3 or higher,
a washing fastness achieved by the second printing control section represents a change in color as prescribed in JIS L 0844 A-2 of grade 1, and
a weight ratio of a coating amount of the pretreatment liquid relative to a coating amount of the ink is set to 0.4 or less for the first printing control section, and set to 0.55 or higher for the second printing control section.

17. The printing system according to claim 12, wherein
a washing fastness achieved by the first printing control section represents a change in color as prescribed in JIS L 0844 A-2 of grade 3 or higher,
a washing fastness achieved by the second printing control section represents a change in color as prescribed in JIS L 0844 A-2 of grade 1,
a weight ratio of a coating amount of the pretreatment liquid relative to a coating amount of the ink is set to 0.4 or less for the first printing control section, and set to 0.55 or higher for the second printing control section, and
the post-treatment device is a drying device for drying the pretreatment liquid and the ink used in the printing device.

18. The printing system according to claim 12, wherein
the post-treatment device comprises a plurality of post-treatment devices for executing the post-treatment under different conditions, and
the printing system control section, based on the read post-treatment control information, executes the post-treatment using a post-treatment device selected from among the plurality of post-treatment devices that matches the post-treatment conditions.

19. The printing system according to claim 12, wherein
the post-treatment device comprises a drying device for drying the pretreatment liquid and the ink used by the printing device,
the drying device has a plurality of drying devices that implement drying at different drying temperatures, and
the printing system control section executes the post-treatment based on the read post-treatment control information, using a drying device among the plurality of drying devices that matches the post-treatment conditions.
